(19) United States
(12) Patent Application Publication
(10) Pub. No.: US 2014/0020561 A1
(43) Pub. Date: Jan. 23, 2014

(54) Segmented stackable filter assembly for filtering a gas and method of manufacturing same

(71) Applicant: Glen Aery, Temecula, CA (US)

(72) Inventor: Glen Aery, Temecula, CA (US)

(21) Appl. No.: 13/507,658

(22) Filed: Jul. 18, 2012

(51) Int. Cl. B01D 29/56; B23P 17/04; B01D 46/42

(52) U.S. Cl. 96/224; 55/483; 55/467; 55/356; 55/481; 55/471; 55/385.1; 29/428

(57) ABSTRACT

Segmented stackable filter assembly for filtering a gas and method of manufacturing same. An exemplary embodiment of the segmented stackable filter assembly comprises a plurality of filter segments stackable end-to-end for varying filtration capacity of the stackable filter assembly. Each filter segment includes an annular outer wire mesh and an annular inner wire mesh spaced apart from the outer wire mesh to define a gap therebetween containing filter media. The inner wire mesh defines a central air flow passage axially through the filter assembly. A lower end plate has an opening for receiving a neck portion upwardly projecting from an adjacent upper end plate, so that both filter segments are prevented from laterally moving relative to each other. A fan assembly is supported by the neck portion for suctioning the gas through the plurality of filter segments.

### FIELD OF THE INVENTION

This invention generally relates to gas separation and more particularly relates to a segmented stackable filter assembly for filtering a gas and method of manufacturing same.

### BACKGROUND OF THE INVENTION

It is important to decrease air pollution because air pollution has undesirable effects on human health. Short-term health effects of air pollution include eye and nose irritation, bronchitis, pneumonia, headache, nausea and allergic reactions. Also, short-term effects of air pollution can exacerbate other ailments, such as asthma and emphysema. Long-term health effects of air pollution include chronic respiratory disease, lung cancer, heart disease, possible brain damage, neurological disorders, damage to liver and kidneys, as well as other undesirable health effects. According to the World Health Organization, 2.4 million people die each year from ailments directly related to air pollution. In addition, according to information published by the American Chemical Society, more than 500,000 Americans die each year from cardiopulmonary disease that is correlated with breathing fine particle air pollution. Air pollution tends to have its greatest impact on the most vulnerable, including growing children and the elderly.

Air pollution also has an economic impact. In this regard, it is estimated that healthcare costs, lost productivity in the workplace due to worker absences and other effects cost billions of dollars each year. For example, the European Union Environmental Agency estimated that in 2009, healthcare and environmental costs totaled about $130 billion. In the United States, healthcare costs due to outdoor pollutants ranged from $40 billion to $50 billion in 2000. In addition to increased healthcare costs, air pollution has been linked to reduced plant growth and crop yields, thereby necessarily increasing food costs.

Moreover, damage to plants may become evident even before health damage to humans. Undesirable effects on plants is evinced by mottled foliage, dried leaf tips and margins, twig dieback (i.e., infection advancing from blighted leaves directly into the stem), stunted growth, premature leaf drop, delayed maturity, early drop of blossoms, and reduced quality. For example, ozone, which is probably the most important plant-toxic air pollutant in the United States, causes tissue collapse, interveinal necrosis (i.e., death of cells and tissue), stipple (i.e., pigmented marks) on the upper surface of leaves, mottling, bronzing, and bleaching. Ozone pollution also stunts plant growth and depresses flowering and bud formation, in addition to causing scorching of leaves.

Regulations for abatement of air pollution exist internationally due to the global extent of air pollution. For example, the United Kingdom, Australia and Canada have enacted regulations to reduce air pollution. In addition, the European Environmental Agency, which is an agency of the European Union and which includes 32 member states and seven cooperating countries, has found air pollution to be an important enough consideration that it expends considerable resources to monitor and provide independent information concerning environmental air pollution. Thus, air pollution has a global impact as well as a localized national impact.

The purpose of the regulations mentioned hereinabove is to control sources of air pollution. These sources include smoke stacks of power plants; manufacturing facilities; waste incinerators; furnaces; biomass burning including wood burning, crop waste, and dung burning; motor vehicles; crop dusting; controlled-burned activities used in agricultural and forestry management; fumes from chemicals, including paint and aerosols; asphyxiants, such as methane from landfills; the carcinogen, radon (Rn) gas, exuded from the earth and found in confined spaces in homes and offices; smoke and carbon from wildfires; and other sources.

However, outdoor air quality has improved dramatically during the last 40 years in the United States since Congressional passage of the Clean Air Act that was signed into law on Dec. 31, 1970. The purpose of the Clean Air Act (CCA), which regulates air emissions from stationary and mobile sources and which is codified at 42 U.S.C §7401 et seq., is to combat air pollution in the United States and protect the health and general welfare of United States citizens with respect to air pollutants. The CCA, and its subsequent amendments, requires federal agencies, state and local governments and polluters in business and industry to implement measures that decrease air pollution by complying with air quality standards. Specific federal regulations regarding air quality compliance are found at 40 C.F.R., Parts 50-59. The Environmental Protection Agency (EPA), which was established on Dec. 2, 1970, conducts research, monitoring and setting of standards, as well as enforcement of federal air quality standards.

The EPA estimates that during the first 20 years after passage, the CCA was instrumental in avoiding more than 200,000 deaths and 700,000 cases of bronchitis. During the last 20 years, total emissions of six principal pollutants have decreased by more than 41 percent, while the Gross Domestic Product (i.e., market value of all officially recognized finished goods and services produced within a country in a given period) has increased by more than 64 percent. The six principal pollutants referred to hereinabove are ozone (O₃), particulate matter pollution (PM), lead (Pb), nitrogen dioxide (NO₂), carbon monoxide (CO), and sulfur dioxide (SO₂). The combined emissions of the six principal pollutants and their precursors decreased 59 percent on average since 1990, even though the U.S. economy grew, vehicles were driven more miles, and population and energy use increased. Therefore, air pollution abatement efforts have resulted in improved air quality, particularly outdoor air quality.

However, although outdoor air quality has improved significantly during the last four decades, indoor air quality remains a concern. According to the World Health Organization, about 1.5 million people die each year due to indoor air pollution. For example, radon gas can become trapped inside homes and workplaces; building materials, such as carpeting and plywood can emit formaldehyde (H₂CO) gas; paints and solvents can emit volatile organic compounds during drying; and lead paint particles can become air-borne and inhaled. All of these substances adversely affect the health status of humans as well as growth of indoor plants. In addition, aerosol air fresheners; wood burning in fireplaces; pesticides used on indoor plants; hydrogen sulfide from sewer gas emanating from faulty traps of drain pipes; household and workplace cleaning compounds; tetrachloroethylene fumes from clothing recently dry cleaned; air-borne asbestos fibers in some older buildings; as well as other pollutants that exist in indoor environments can also adversely affect the health status of humans as well as growth of indoor plants. In addition, reduced indoor air circulation may allow these air-borne pollutants to accumulate to a level that is more than exists outdoors where air circulation is greater. Therefore, it is desirable to decrease indoor air pollution, even though there has been a significant overall reduction in outdoor air pollution.

Control of indoor air pollution is typically accomplished by use of air filter devices. Such devices include air filter media for removal of particles from the air. More specifically, mechanical air filters, such as High Efficiency Particulate Air (HEPA) filters, remove particles from the air by capturing the particles on filter materials. However, these air filters are not effective in removing larger particles because larger particles tend to settle from the air before reaching the filters. Another device used as a residential and office air cleaner is the electrostatic air cleaner that uses electrostatic precipitators to capture electrically charged particles. In this regard, air is drawn through an ionization section to impart an electrical charge to the particles. The charged particles in the ionization section accumulate on plates that are oppositely charged. The oppositely charged plates containing the accumulated particles are subsequently cleaned or discarded. Gas-phase air filters, on the other hand, remove gases and odors using a sorbent material, such as activated carbon, that absorbs the pollutants. Such gas-phase air filters remove gases that are specific to one or a specific number of gaseous pollutants. It is noted, however, that carbon monoxide, which is produced by burning gas, oil, kerosene, wood or charcoal, is not easily captured by residential gas-phase filters. Also, gas-phase air filters are not designed to kill microorganisms. In order to kill microorganisms, ultraviolet light (UV) technology is used in some indoor air cleaners. More specifically, UV light technology uses ultraviolet light to generate ozone that destroys biological pollutants. These biological pollutants include viruses, bacteria, allergens, and molds that grow on HVAC surfaces, such as cooling coils, drain pans and duct work. However, use of UV light alone does not provide for filtration of particles and ozone can irritate lung tissue. A variant of this latter design uses UV light in combination with a catalyst that reacts with the UV light in a manner that converts gaseous pollutants into benign by-products. However, such photocatalytic purifiers also produce ozone, which is itself arguably toxic. Therefore, several technologies exist for removal of indoor air pollutants. However, these technologies have disadvantages as well as advantages associated with them, as indicated hereinabove.

Some indoor air filters are designed to be portable in order to move the air filter from room to room. However, many commercially available indoor portable air filters do not have capacity to remove large particles, such as pollen, dust mites, cockroach allergens and other large particulate matter. In some cases, such commercially available indoor portable air filters lack means for increasing capacity without purchasing a replacement unit having greater capacity. In other words, when a greater capacity indoor air filter is needed, the current indoor air filter unit is completely discarded and the user must then purchase a new indoor air filter unit. In addition, some portable air filters are marketed without fans in order to reduce noise levels due to operation and vibration of the fan. However, portable air filters without fans are less effective for pollutant removal compared to portable air filters with fans. In addition, some air filter designs, particularly gas-phase air filters, lack an ability for the user to conveniently change-out depleted filter media without discarding the entire air filter device. This disadvantage increases costs of ownership for gas-phase air filters.

Attempts have been made to address the considerations mentioned hereinabove with respect to removal of indoor air pollutants. For example, U.S. Pat. No. 4,629,482 titled “HEPA Room Air Purifier” and issued Dec. 16, 1986 in the name of George B. Davis relates to portable air purifiers which utilize High Efficiency Particulate Air (HEPA) filters. According to this patent, portable air filters are provided having replaceable and generally cylindrical high efficiency particulate air filters which are mounted to receive incoming air that is drawn therethrough by centrifugal fans. The filters may be combined in series or stacked relative to one another in order to increase the overall flow rate through the purifiers. However, this patent does not appear to disclose suitable locking means for locking the stacked filters together, so that the stacked filters retain their stacked configuration if inadvertently “bumped” or otherwise unintentionally disturbed. Also, the air filter disclosed by this patent does not appear designed for removal of gaseous pollutants. That is, this patent does not appear to disclose an air filter designed for filtering a gas by means of adsorption.

Another attempt to address the considerations mentioned hereinabove with respect to removal of indoor air pollutants is U.S. Pat. No. 5,330,722 titled “Germicidal Air Filter” and issued Jul. 19, 1994 in the names of William E. Pick, et al. This patent relates to air purification by filtration and irradiation with an ultraviolet radiation source. According to this patent, a germicidal air purifier for trapping and destroying airborne microorganisms is provided. The air purifier includes an ultraviolet radiation source and juxtaposed filter medium. In a first embodiment, a fixed ultraviolet lamp irradiates a cylindrical air filter which is rotated on its longitudinal axis. In a second embodiment, a radiant lamp fixture is moved reciprocally across an upstream side of a planar filter. In a third embodiment, a radiant lamp fixture is rotated about an axis which is orthogonal to its longitudinal midpoint, so that a circular area of a planar filter is irradiated. Thus, either the ultraviolet radiant lamp fixture or the filter medium is moved. This patent states that moving either the ultraviolet radiant lamp fixture or the filter medium promotes deeper and more thorough irradiation of the filter because the changing angle of incidence of radiation on the filter substantially eliminates shaded areas which naturally occur when a fibrous material is irradiated. This patent also states that an advantage of the air purifier is that microorganisms trapped on the filters are exposed to a lethal dose of radiation and that the air purifier is effective at destroying a significant percentage of airborne microorganisms suspended in air passed through the filter. However, this air purifier does not appear designed to be easily movable, such as being movable from room-to-room in a home, office or other building structure. In addition, multiple units of this air purifier do not appear stackable. Moreover, this patent does not appear to disclose an air purifier designed for filtering a gas by means of adsorption.

Yet another attempt to address the considerations mentioned hereinabove with respect to removal of indoor air pollutants is U.S. Patent Application Publication No. 2006/0277875 titled “Stackable Air Purifier System With Expandable Housing” and published on Dec. 14, 2006 in the name of Daniel E. Schuld. This published patent application relates to an air cleaner having stackable filter units for easy replacement or addition of filters. According to this published patent application, an air purifier includes a base, one or more filter units and a cover unit. The base has a housing, a blower, vents in the housing for the egress of air from the blower, a first channel providing ingress of air to the blower and a connector on the housing. At opposing ends of the filter unit are the connectors configured to matingly engage with the connectors of an adjacent filter unit. The last filter unit mounted is engaged with a cover having a housing and another connector, so that the connectors engage with a connector on an adjacent unit. Although this published patent application discloses a connector configured to matingly engage with the connector of an adjacent unit, this published patent application does not appear to disclose the configuration of any of the locking mechanisms described and claimed hereinbelow.

Although the approaches recited hereinabove disclose various devices for removal of indoor air pollution, the approaches recited hereinabove do not appear to disclose the invention described and claimed hereinbelow.

### SUMMARY OF THE INVENTION

The present invention addresses the shortcomings of the prior art approaches mentioned hereinabove by providing a segmented stackable filter assembly for filtering a gas and method of manufacturing same.

The segmented stackable filter assembly as disclosed and claimed herein is capable of removing undesirable air-borne gaseous contaminants, such as, for example, paint fumes, tobacco smoke, mold, mildew, pet odors, cooking odors, hydrocarbons and other malodorous and gaseous contaminants. The segmented stackable filter assembly is also modular in the sense that virtually any desired number of air filter segments can be used to obtain a desired air filtering capacity. In one exemplary embodiment, the filter segments of the stackable filter assembly are arranged vertically one upon the other in a manner that defines a column of stacked filter segments. In an additional embodiment, the segmented stackable filter assembly is conveniently portable either before assembly or after assembly. Before assembly, each of the filter segments may be individually transported from one location to another location by wheels attached thereto. After assembly, the column of stacked filter segments may be relocated by means of a wheeled platform upon which the column of stacked filter segments is disposed.

In yet another exemplary embodiment, each filter segment comprises an annular first grate or first wire mesh having a first end portion and a second end portion. Disposed inwardly of the first wire mesh, and spaced apart therefrom, is an annular second grate or second wire mesh. The second wire mesh also has a first end portion and a second end portion. The second wire mesh also has an outside diameter less than the inside diameter of the first wire mesh, so as to define an annular space or gap therebetween. The gap is filled with a filter media, such as activated carbon, for removal of undesirable air-borne gaseous contaminants. The annular second wire mesh defines a centrally disposed air flow passage therethrough for reasons disclosed momentarily.

Mounted atop and laterally spanning the first wire mesh, filter media in the gap, second wire mesh and air flow channel or passage is an upper end plate. In addition, if desired, mounted atop the upper end plate may be an annular elastomeric gasket or seal for sealing an interface between adjacent filter segments. Sealing such an interface ensures air enters the central air passage only through the filter media, rather than through such an interface, so that the air flow entering the central air flow passage does not bypass the filter media and so that the air is efficiently filtered by the filter media. The elastomeric seal also reduces noise and vibration while a fan assembly included with the segmented stackable filter assembly is operated. Each upper end plate includes an upwardly projecting extension or neck portion having a central bore for passage of air through the neck portion. The neck portion that belongs to each upper end plate engages a lower end plate of an adjacent filter segment in order to restrain lateral movement of the filter segments and to assist in maintaining the filter segments in alignment and stable while the filter segments are stacked one upon the other.

Mounted on the bottom of and laterally spanning the first wire mesh, the filter media in the gap, second wire mesh and air flow passage is the previously mentioned lower end plate. The lower end plate defines a centrally formed opening for receiving the previously mentioned neck portion that belongs to an adjacent filter segment. In other words, the neck portion of a lower filter segment will be received through the opening of an adjacent upper filter segment for assisting alignment and stability of adjacent filter segments by preventing lateral movement of the lower filter segment relative to the adjacent upper filter segment or lateral movement of the upper filter segment relative to the adjacent lower filter segment. The previously mentioned motorized fan assembly is removably connected to the neck portion of the uppermost or top filter segment. The previously mentioned seal reduces noise and vibration due to vibration of the fan assembly. The fan blades belonging to the fan assembly are in communication with the bore of the uppermost neck portion for drawing surrounding air through the first wire mesh, filter media, second wire mesh and into the central air flow passage of all stacked filter segments. The air drawn into the central air flow passage of all stacked filter segments is thereafter drawn upwardly by operation of the fan assembly and exhausts through the fan's outlet. The fan assembly is connected to an electrical power source, such as electrical wall outlet.

Although the exemplary embodiments of the segmented stackable filter assembly is summarized hereinabove as configured for vertical orientation, other embodiments allow the segmented stackable filter assembly to be oriented horizontally. Such horizontal orientation may be useful for deployment in horizontally disposed air ducts or other horizontal structures.

In addition, although the exemplary embodiments of the segmented stackable filter assembly are summarized hereinabove as configured for removal of gaseous pollutants, another embodiment includes a removable fibrous prefilter that allows the segmented stackable filter assembly to remove air-borne particulate matter. Such a prefilter may be in the form of a removable, flexible shroud capable of being wrapped around the filter segment and attached thereto by hook-and-loop fasteners (e.g., Velcro®brand fasteners) for capturing certain air-borne particulate matter in the shroud. Thus, the segmented stackable filter assembly is configured to remove both gaseous contaminates and particulate contaminates. This feature of the invention avoids the need for the user to separately purchase a gas-phase air filter in addition to a particulate air filter.

Due to its modular construction, the segmented stackable filter assembly can be readily reconfigured to vary air filtering capacity by varying the number of filter segments that are stacked. This feature of the segmented stackable filter assembly avoids the cost of purchasing a replacement air filter unit if greater or lesser air cleaning capacity is found to be needed. In addition, according to one exemplary embodiment, the segmented stackable filter assembly is more conveniently portable than prior art devices because it can be easily transported from room-to-room in a residence, office or other building structure. Moreover, filter segments of the segmented stackable filter assembly are releasably interlocked for avoiding separation of the filter segments should the column of stacked filter segments be inadvertently “bumped” or otherwise unintentionally disturbed. In other exemplary embodiments, not only does the segmented stackable filter assembly remove gaseous pollutants, the segmented stackable filter assembly also destroys microorganisms by use of a suitable ultraviolet light source. Thus, embodiments of the segmented stackable filter assembly are economical, easily reconfigurable to vary air cleaning capacity, mechanically stable even when inadvertently “bumped” or otherwise unintentionally disturbed, and conveniently transportable.

According to an aspect of the present invention, there is provided a segmented stackable filter assembly for filtering a gas, comprising: a first filter segment having a first filter media disposed therein for filtering the gas, the first filter segment having a neck portion; and a second filter segment mountable on the first filter segment and having a second filter media disposed therein for filtering the gas, the second filter segment being adapted to receive the neck portion for restraining lateral movement of the second filter segment relative to the first filter segment, or optionally for restraining lateral movement of the first filter segment relative to the second filter segment.

According to another aspect of the present invention, there is provided a segmented stackable filter assembly for filtering a gas, comprising a plurality of filter segments mountable one upon the other, each of the filter segments including: an annular outer wire mesh having a first end portion and a second end portion; an annular inner wire mesh centered inwardly of the outer wire mesh and spaced apart therefrom for defining a gap therebetween sized to receive a filter media therein, the inner wire mesh defining a centrally-located gas flow channel in communication with the filter media, the inner wire mesh having a first end portion and a second end portion; a first end plate spanning the first end portion of the outer wire mesh, and the first end portion of the inner wire mesh and the filter media therebetween, the first end plate defining an opening therethrough in communication with the gas flow channel; a second end plate coextensive with the first end plate and spaced apart therefrom for defining a filtering zone sized to collectively receive the outer wire mesh, the filter media and the inner wire mesh, the second end plate having an outwardly extending neck portion defining a bore therethrough in communication with the gas flow channel, the neck portion being receivable in close-fitting relationship in the opening defined by the first end plate for restraining lateral movement of the first end plate relative to the second end plate, whereby lateral movement of the filter segment is restrained while lateral movement of the first end plate relative to the second end plate is restrained; an elastomeric seal interposed between the second end plate and the first end plate for sealing an interface therebetween, whereby the seal prevents the gas from entering the interface while the seal is interposed between the second end plate and the first end plate; an electrically operable fan removably supportable by the neck portion and in communication with the bore for suctioning the gas through the outer wire mesh, the filter media, the inner wire mesh, the gas flow channel and the bore, whereby the gas is filtered and removed from the filter segment while the gas is suctioned through the outer wire mesh, the filter media, the inner wire mesh, the gas flow channel and the bore; and a fastener arrangement adapted to releasably interconnect adjacent ones of the plurality of filter segments.

According to yet another aspect of the present invention there is provided a method of manufacturing a segmented stackable filter assembly for filtering a gas, comprising the steps of: providing a first filter segment having a first filter media disposed therein for filtering the gas, the first filter segment having a neck portion; providing a second filter segment mountable on the first filter segment for defining a column of stacked filter segments, the second filter segment having a second filter media disposed therein for filtering the gas; and adapting the second filter segment to receive the neck portion for restraining lateral movement of the second filter segment relative to the first filter segment, or optionally for restraining lateral movement of the first filter segment relative to the second filter segment.

A feature of the present invention is the provision of a first filter segment having a neck portion engageable with an adjacent second filter segment for restraining lateral movement of the first filter segment and second filter segment relative to each other.

Another feature of the present invention is the provision of a seal adapted to be interposed between the first filter segment and the second filter segment for sealing an interface therebetween.

An additional feature of the present invention is the provision of a platform adapted to be removably connected to a column of the stacked filter segments for supporting the column of stacked filter segments thereon.

A further feature of the present invention is the provision of a plurality of wheels connected to the platform for transporting the platform and the column of stacked filter segments supported thereon.

Another feature of the present invention is the provision of a plurality of wheels connected to individual ones of the plurality of filter segments for transporting individual ones of the filter segments, or optionally for transporting the column of stacked filter segments without use of the wheeled platform.

Another feature of the present invention is the provision of an ultraviolet light source connected to at least one of the first filter segment and the second filter segment for sanitizing the gas by supplying a lethal dose of ultraviolet radiation to the gas in order to kill microorganisms present in the gas.

An additional feature of the present invention is the provision of a fastener arrangement associated with the first filter segment and the second filter segment for releasably interconnecting the first filter segment and the second filter segment.

Still another feature of the present invention is the provision of a first replaceable filter cartridge adapted to be disposed in the first filter segment, the first filter cartridge containing the first filter media, and a second replaceable filter cartridge adapted to be disposed in the second filter segment, the second filter cartridge containing the second filter media.

Yet another feature of the present invention is the provision of a first filter segment and a second filter segment comprising a first hinged door and a second hinged door, respectively, for allowing access to the first replaceable filter cartridge and the second replaceable filter cartridge disposed therein.

In addition to the foregoing, various other method and/or device aspects and features are set forth and described in the teachings, such as text (e.g., claims and/or detailed description) and/or drawings of the present invention.

The foregoing is a summary and thus may contain simplifications, generalizations, inclusions, and/or omissions of detail. Consequently, those skilled in the art will appreciate that the summary is illustrative only and is not intended to be in any way limiting. In addition to the illustrative aspects, embodiments, and features described hereinabove, further aspects, embodiments, and features will become apparent by reference to the drawings and the following detailed description.

### BRIEF DESCRIPTION OF THE DRAWINGS

The invention will be more fully understood by reference to the detailed description in conjunction with the following figures, wherein:

FIG. 1 is a view in elevation of a first embodiment segmented stackable filter assembly, this view showing a plurality (i.e., at least two) of filter segments vertically stacked one upon the other to define a column of stacked filter segments, each filter segment being cylindrical and having a circular transverse cross-section, this view also showing a fan assembly mounted on a neck portion of an uppermost filter segment for suctioning polluted air through the column of stacked filter segments;

FIG. 2 is a view taken along section line 2-2 of FIG. 1;

FIG. 3 is a view in partial elevation of the first embodiment segmented stackable filter assembly;

FIG. 4 is a view in vertical section of one of the filter segments belonging to the first embodiment segmented stackable filter assembly;

FIG. 5 is a view taken along section line 5-5 of FIG. 4;

FIG. 6 is a view in partial elevation of a second embodiment segmented stackable filter assembly, this view showing a column of stacked filter segments disposed on a wheeled platform;

FIG. 7 is a view in partial elevation of a third embodiment segmented stackable filter assembly, this view showing a column of stacked filter segments, each of the filter segments thereof having a plurality of wheels connected thereto;

FIG. 8 is a view in vertical section of a fourth embodiment segmented stackable filter assembly, this view showing an ultraviolet light source connected to an exterior surface of at least one of the filter segments;

FIG. 9 is a view in vertical section of a fifth embodiment segmented stackable filter assembly, this view showing an ultraviolet light source connected to an interior surface of at least one of the filter segments;

FIG. 10 is a view in vertical section of a sixth embodiment segmented stackable filter assembly, this view showing two filter segments thereof releasably interlocked by means of a plurality of clamp fastener arrangements;

FIG. 11 is a fragmentary view in vertical section of one of the clamp fastener arrangements in an unlocked state;

FIG. 12 is a fragmentary view in vertical section of one of the clamp fastener arrangements in a locked state;

FIG. 13 is a view taken along section line 13-13 of FIG. 10 and shows some of the plurality of clamp fastener arrangements in an unlocked state and some of the plurality of clamp fastener arrangements in a locked state;

FIG. 14 is a view in vertical section of a seventh embodiment segmented stackable filter assembly, this view showing two filter segments thereof releasably interlocked by means of the clamp fastener arrangements, this seventh embodiment segmented stackable filter assembly not including the neck portion on each filter segment, this view also showing the fan assembly supported by a removable basket disposed within an uppermost filter segment rather than being mounted on a neck portion of the uppermost filter segment;

FIG. 15 is a fragmentary view in vertical section of an eighth embodiment segmented stackable filter assembly, this view showing one of the clamp fastener arrangements in a locked state and deployed in combination with an optional annular seal interposed between an upper filter segment and a lower filter segment;

FIG. 16 is a fragmentary view in vertical section of a ninth embodiment segmented stackable filter assembly, this view showing two filter segments thereof releasably interlocked by means of a plurality of internally threaded fastener arrangements, this view also showing the plurality of internally threaded fastener arrangements in combination with an optional annular seal interposed between adjacent filter segments;

FIG. 17 is a view in taken along section line 17-17 of FIG. 16;

FIG. 18 is a fragmentary view in vertical section of a tenth embodiment segmented stackable filter assembly, this view showing two filter segments thereof releasably interlocked by means of a plurality of externally threaded fastener arrangements, this view also showing the plurality of externally threaded fastener arrangements in combination with an optional annular seal interposed between adjacent filter segments;

FIG. 19 is a view in vertical section of an eleventh embodiment segmented stackable filter assembly, this view showing two filter segments thereof interlocked by means of a plurality of pin fastener arrangements, this view also showing the plurality of pin fastener arrangements in combination with an optional annular seal interposed between adjacent filter segments;

FIG. 20 is a view taken along section line 20-20 of FIG. 19;

FIG. 21 is a fragmentary view in vertical section of the eleventh embodiment segmented stackable filter assembly, this view showing one of the plurality of pin fastener arrangements belonging to a lower filter segment engaging an upper filter segment in combination with an optional annular seal interposed between the upper filter segment and the lower filter segment;

FIG. 22 is a view in partial elevation of a twelfth embodiment segmented stackable filter assembly, each filter segment thereof including a replaceable filter cartridge;

FIG. 23 is a view in vertical section of one of the filter segments belonging to the twelfth embodiment segmented stackable filter assembly;

FIG. 24 is a view in taken along section line 24-24 of FIG. 23;

FIG. 25 is a perspective view in horizontal section of an individual one of the filter segments belonging to the twelfth embodiment segmented stackable filter assembly, this view showing the twelfth embodiment segmented stackable filter assembly having the replaceable cassette installed;

FIG. 26 is a perspective view in horizontal section of an individual one of the filter segments belonging to the twelfth embodiment segmented stackable filter assembly, this view showing the twelfth embodiment segmented stackable filter assembly not having the replaceable cassette installed, the replaceable cassette having been removed for purpose of replacement;

FIG. 27 is a plan view of a thirteenth embodiment segmented stackable filter assembly, wherein each filter segment of the thirteenth embodiment segmented stackable filter assembly is parallelepiped-shaped or box-shaped, so as to have a square or rectangular transverse cross-section;

FIG. 28 is a view in horizontal section of the thirteenth embodiment segmented stackable filter assembly including an installed, replaceable filter cassette;

FIG. 29 is a perspective view in horizontal section of an individual one of the filter segments belonging to the thirteenth embodiment segmented stackable filter assembly that includes an installed, replaceable filter cassette;

FIG. 30 is a perspective view in horizontal section of an individual one of the filter segments belonging to the thirteenth embodiment segmented stackable filter assembly, this thirteenth embodiment not including an installed, replaceable filter cassette, the filter cassette having been removed for purpose of replacement;

FIG. 31 is a perspective view in horizontal section of a fourteenth embodiment segmented stackable filter assembly, this view showing a prefilter shroud surrounding at least one of the filter segments;

FIG. 32 is a perspective view in horizontal section of a fifteenth embodiment segmented stackable filter assembly, this view showing an individual one of the filter segments containing a removable filter cartridge, this view also showing the filter segment having a hinged door (shown in phantom) for access to the filter cartridge;

FIG. 33 is a view in perspective of a sixteenth embodiment segmented stackable filter assembly disposed in a substantially horizontal structure (shown in phantom), such as a building's air ventilation duct;

FIG. 34 is an exploded view of the sixteenth embodiment segmented stackable filter assembly;

FIG. 35 is an exploded view of a seventeenth embodiment segmented stackable filter assembly that can be disposed in the substantially horizontal structure, such as a building's air ventilation duct;

FIG. 35A is a view in perspective of an eighteenth embodiment segmented stackable filter assembly;

FIG. 35B is a fragmentary view in partial elevation of the eighteenth embodiment segmented stackable filter assembly;

FIG. 35C is a fragmentary view in partial elevation of a nineteenth embodiment segmented stackable filter assembly;

FIG. 36 is a fragmentary view in perspective of a twentieth embodiment segmented stackable filter assembly configured for removable connection to a face mask;

FIG. 37 is a fragmentary view in vertical section of the twentieth embodiment segmented stackable filter assembly; and

FIG. 38 is a flowchart showing an illustrative method of manufacturing a segmented stackable filter assembly.

### DETAILED DESCRIPTION OF PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from either the spirit or scope of the invention.

In addition, the present patent specification uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

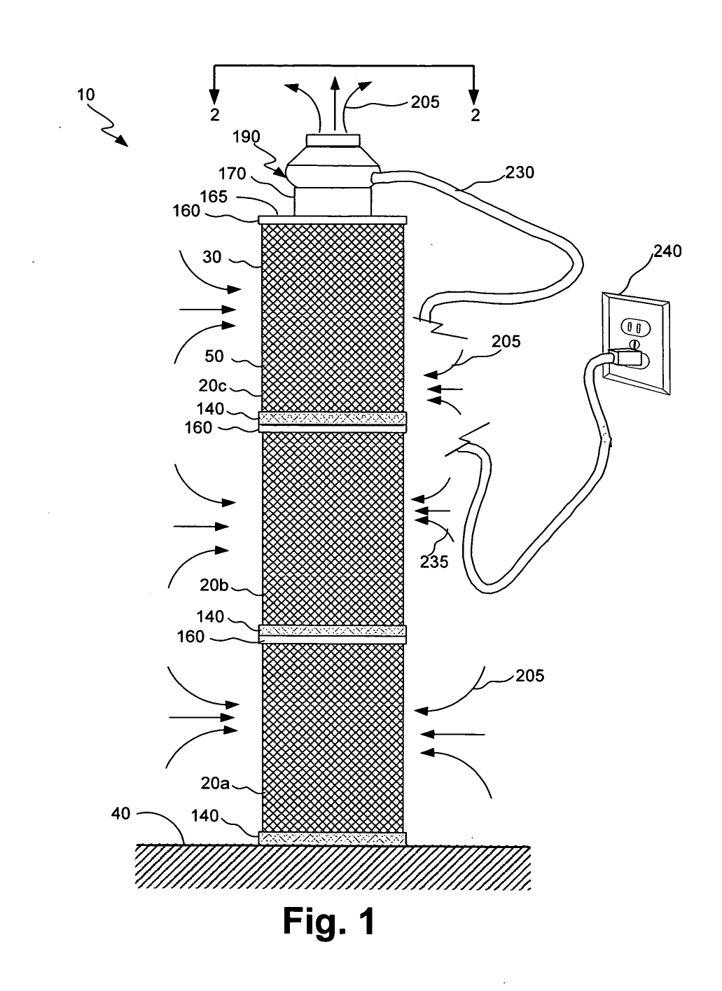

Therefore, with reference to FIGS. 1, 2, 3, 4 and 5, there is shown a first embodiment segmented stackable filter assembly, generally referred to as 10 (hereinafter “stackable filter assembly 10”), for filtering a gas, such as indoor room air. The room air may contain pollutants harmful to human health and damaging to indoor plants. For example, the pollutants may include harmful gases, such as ozone (O₃), nitrogen dioxide (NO₂), carbon monoxide (CO), sulfur dioxide (SO₂), naturally occurring radon, and environmental tobacco smoke (ETS). Indoor pollutants may also include volatile organic compounds (VOCs), such as formaldehyde, pesticides found in many household products, and airborne lead and mercury vapors from old paint. Other undesirable air-borne gaseous contaminants may be, for example, mold, mildew, pet odors, cooking odors, hydrocarbons and other malodorous and gaseous contaminants. It is desirable to remove these pollutants from indoor air in order to avoid risk to human health and damage to indoor plants.

Referring again to FIGS. 1, 2, 3, 4 and 5, stackable filter assembly 10 comprises a plurality of identical, generally cylindrical filter segments, such as first filter segment 20a, second filter segment 20b, and third filter segment 20c. As described in detail hereinbelow, stackable filter assembly 10 is conveniently expandable. Although three filter segments 20a, 20b and 20c are shown for purposes of illustration, it will be appreciated that virtually any number greater than one of filter segments may comprise stackable filter assembly 10. As described in more detail hereinbelow, filter segments 20a, 20b and 20c are vertically stackable one upon the other, so as to define a column 30 of stacked filter segments. Column 30 is shown supported on a surface 40, such as the surface of a floor in a business establishment, residence or other confined space needing air filtration. However, surface 40 need not be a floor; rather, surface 40 may be any suitable surface, such as a fireplace mantel, kitchen or bathroom countertop, plant greenhouse work table, or other surface. The material comprising various components of each filter segment 20a, 20b and 20c may be manufactured from a corrosion-resistant, light-weight plastic, such as high density polyethylene, polypropylene, nylon, rubber, glass fiber, polycarbonate, as well as other suitable plastic materials. Alternatively, the material comprising various components of each filter segment 20a, 20b and 20c may be manufactured from a corrosion-resistant, light-weight metal, such as thin gauge stainless steel, aluminum or alloys thereof. As yet another alternative, the material comprising various components of each filter segment 20a, 20b and 20c may be manufactured from a corrosion-resistant, light-weight composite, such as fiberglass, cermet (i.e., ceramic and metal composition), carbon graphite with carbon reinforcing fibers, as well as other composites. Manufacturing the various components of each filter segment 20a, 20b and 20c from light weight plastic, composites or thin gauge metal allows individual filter segments 20a, 20b and 20c and the column 30 of filter segments to be easily transportable by a user of stackable filter assembly 10, as described in more detail hereinbelow. Also, manufacturing the components of each filter segment 20a, 20b and 20c from a corrosion-resistant material increases service life of stackable filter assembly 10 by resisting corrosion even in high humidity room environments. The various components of filter segments 20a, 20b and 20c are described hereinbelow.

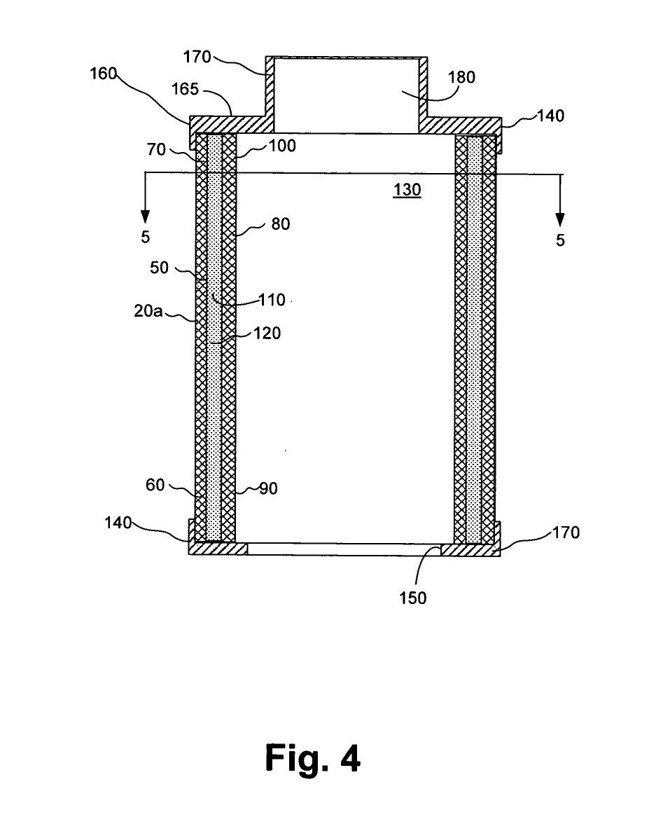

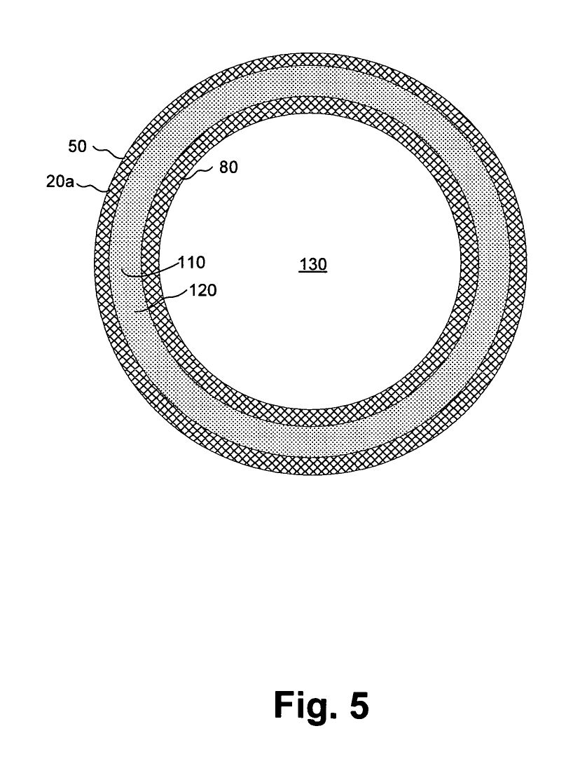

As best seen in FIGS. 4 and 5, each of the identical filter segments 20a, 20b and 20c comprises a particularized structure for filtering the room air therethrough. In this regard, each filter segment 20a, 20b and 20c comprises an annular first or outer wire mesh 50 having a first end portion 60 and a second end portion 70. Centrally disposed inwardly of first wire mesh 50, and spaced apart therefrom, is an annular second or inner wire mesh 80. Inner wire mesh 80 also has a first end portion 90 and a second end portion 100. Inner wire mesh 80 has an outside diameter less than the inside diameter of outer wire mesh 50, so as to define an annular space or gap 110 therebetween. Gap 110 is filled with a preselected sorbent filter media 120, such as activated carbon (C). The terminology “activated carbon” is defined herein to mean charcoal chemically activated with a suitable chemical (e.g., phosphoric acid) to increase porosity for increased adsorption of gases in order to remove at least some of the undesirable air-borne gaseous contaminants mentioned hereinabove. Alternatively, filter media 120 may be other sorbent material, such as the activated carbon impregnated with a reactive agent. The reactive agent reacts with the gases contained in the room air and forms stable chemical compounds that are bound to filter media 120 as organic or inorganic salts, or are disassociated and filtered into the room air as, for example, carbon dioxide and water vapor. Examples of reactive agents that may be suitable for this purpose include reactive agents selected from the group consistently essentially of zinc chloride (ZnCl₂), iodine (I), silver (Ag), aluminum (Al), manganese (Mn), zinc (Zn), iron (Fe), lithium (Li), calcium (Ca) and combinations thereof. Also, filter media 120 need not contain activated carbon. Rather, if desired, filter media 120 may be an adsorbent composition selected from the group consisting essentially of silica gel, activated alumina, zeolites, synthetic polymers, porous clay minerals and combinations thereof.

Referring again to FIGS. 4 and 5, annular second wire mesh 80 defines a centrally-located gas or air flow channel or passage 130 therethrough for reasons disclosed momentarily. Air flow passage 130 extends from first end portion 90 to second end portion 100 of each filter segment 20a, 20b and 20c for flow of air axially through each filter segment 20a, 20b and 20c. Laterally spanning first end portion 60 of first wire mesh 50, a lower end portion of filter media 120 that is disposed in gap 110, first end portion 90 of inner wire mesh 80, and air flow passage 130 is an annular first or lower end plate 140. The lower end plate 140 is attached to outer wire mesh 50 by any suitable means, such as by a single continuous weldment (not shown) or by a plurality of weldments (not shown) or by screws (also not shown), if lower end plate 140 is manufactured from metal. Alternatively, lower end plate 140 is attached to outer wire mesh 50 by a suitable adhesive (not shown) or by screws (also not shown), if lower end plate 140 is manufactured from a plastic or composite. Adhesives suitable for this purpose include epoxy (e.g., containing bisphenol-A or epichlorohydrin), hot-melt adhesives (e.g., ethylene-vinyl acetate), resins (e.g., thermoplastic polyamide), acrylics (e.g., acrylic polymer), or silicones. Lower end plate 140 defines a circular opening 150 centrally formed therethrough and axially aligned with air flow passage 130 for reasons disclosed hereinbelow.

Referring yet again to FIGS. 4 and 5, mounted atop and laterally spanning second end portion 70 of outer wire mesh 50, an upper end portion of filter media 120, second end portion 100 of inner wire mesh 80, and airflow passage 130 is an upper end plate 160 that has an upper surface 165. Upper end plate 160 is spaced apart from lower end plate 140 and defines a “filtering zone” therebetween for filtering the room air, as described in detail hereinbelow. Upper end plate 160 is attached to outer wire mesh 50 by any suitable means, such as by a single continuous weldment (not shown) or by a plurality of weldments (not shown) or by screws (also not shown) if upper end plate 160 is manufactured from metal. Alternatively, upper end plate 160 may be attached to outer wire mesh 50 by a suitable adhesive or by screws, if upper end plate 160 is manufactured from a plastic or composite. In addition, integrally connected to and vertically, outwardly projecting from upper surface 165 of upper end plate 160 is an annular extension or neck portion 170 for reasons disclosed presently. Extending centrally through neck portion 170 is a longitudinal bore 180 aligned with air flow passage 130 and in communication with air flow passage 130 for receiving air flowing upwardly through air flow passage 130 in a manner disclosed hereinbelow.

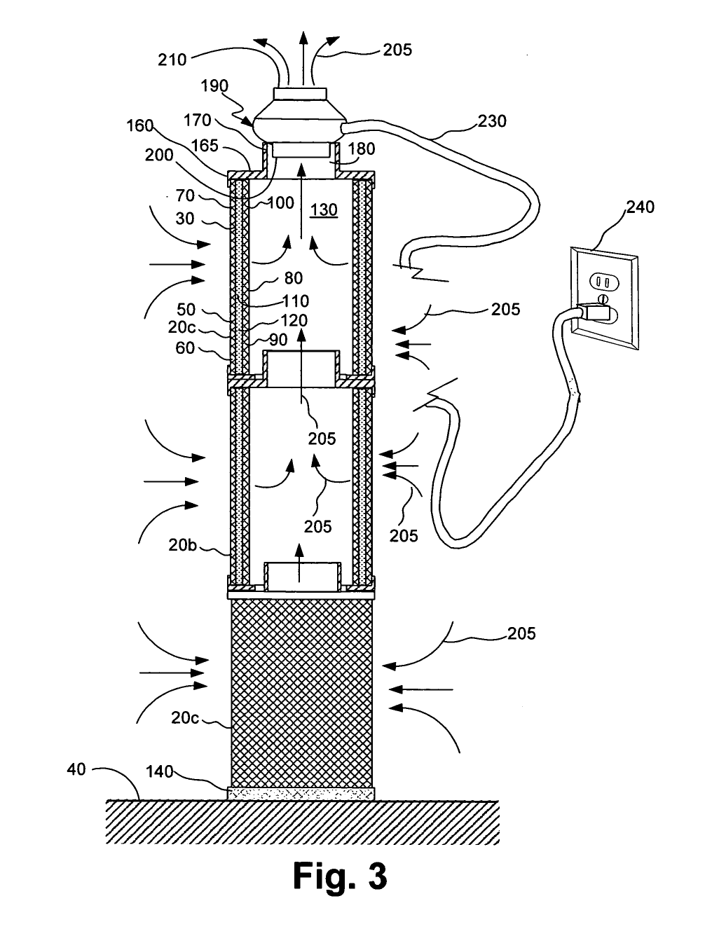

With reference to FIGS. 3 and 4, it will be appreciated that neck portion 170 serves a dual purpose. The first purpose of neck portion 170 is to prevent any one of filter segments 20a, 20b, or 20c from laterally sliding off an adjacent filter segment 20a, 20b, or 20c. More specifically, and as previously mentioned, column 30 is defined by filter segments 20a, 20b, and 20c as filter segments 20a, 20b, and 20c are vertically stacked end-to-end one upon the other. As filter segments 20a, 20b and 20c are vertically stacked end-to-end to define column 30, neck portion 170 is received in close-fitting relationship into opening 150 that is formed in lower end plate 140 of an adjacent filter segment. Neck portion 170 restrains lateral movement of filter segments 20a, 20b and 20c relative to each other and maintains filter segments 20a, 20b and 20c in alignment while the filter segments are stacked one upon the other. Restraining lateral movement of one filter segment relative to an adjacent filter segment prevents either filter segment from sliding laterally away from column 30. This ensures that column 30 will remain intact and not collapse due to any of the filter segments 20a, 20b and 20c sliding laterally away from column 30. In this regard, collapse of column 30 might otherwise occur if the column 30 of stacked filter segments is inadvertently “bumped” or otherwise unintentionally disturbed by the user of stackable filter assembly 10 or, for example, by a household pet. Collapse of column 30 would impair proper functioning of stackable filter assembly 10. A second purpose of neck portion 179 is to support a fan assembly 190, the purpose of which is fully described hereinbelow.

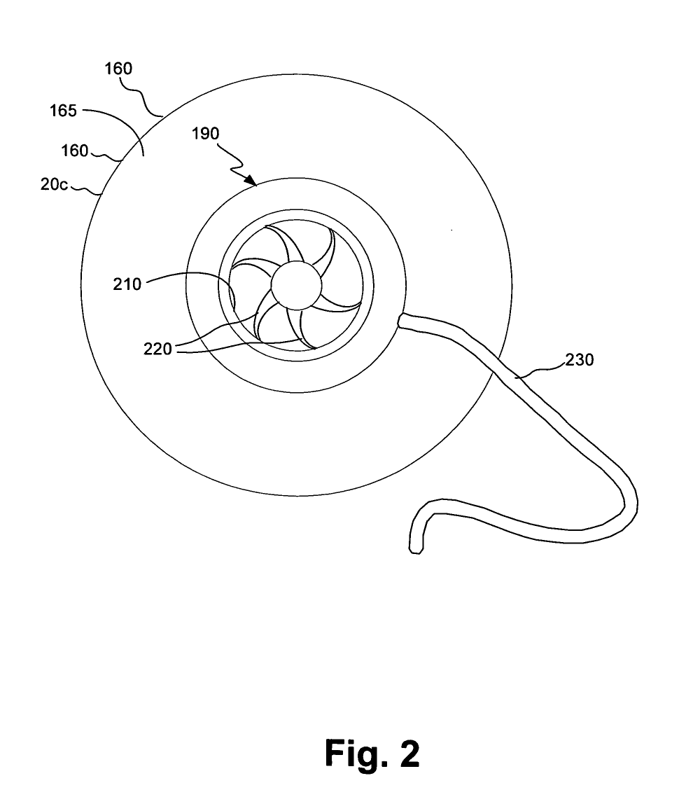

Referring to FIGS. 2 and 3, a suction device, such as previously mentioned fan assembly 190, is removably supported by an upper-most neck portion 170, as shown. Fan assembly 190 is supported by upper-most neck portion 170, such that an air intake 200 of fan assembly 190 is in suction communication with bore 180 that is formed through neck portion 170 for suctioning air through stackable filter assembly 10, such as along air flow lines 205. Air that is suctioned through stackable filter assembly 10 is exhausted through an air exhaust 210 that belongs to fan assembly 190. To obtain this result, fan assembly 190 includes a plurality of fan blades 210 rotatably operated by means of an electric motor (not shown) disposed in fan assembly 190. The power of the electric motor and size and number of fan blades 210 are preselected based on the desired speed of fan blades 210, which is in turn preselected based on the desired air removal capacity for stackable filter assembly 10. The electric motor disposed in fan assembly 190 is connected, via an electricity conducting wire 230, to a suitable power source, such as an electrical wall outlet 240 (see FIG. 1). A commercially available fan assembly that may be suitable for this purpose may be available from Rhino Filter, Incorporated located in Reno, Nev. U.S.A.

With reference to FIGS. 1, 2, 3, 4 and 5, it should be appreciated that stackable filter assembly 10 is configured such that column 30 that is defined by filter segments 20a, 20b and 20c may be separated by removing fan assembly 190 from upper-most neck portion 170 and manually disengaging each neck portion 170 from its respective opening 150. Any one or all of filter segments 20a, 20b and 20c may then be individually transported from one location to another location, such as from one room to another room in a business establishment, residence or any confined space needing air filtration.

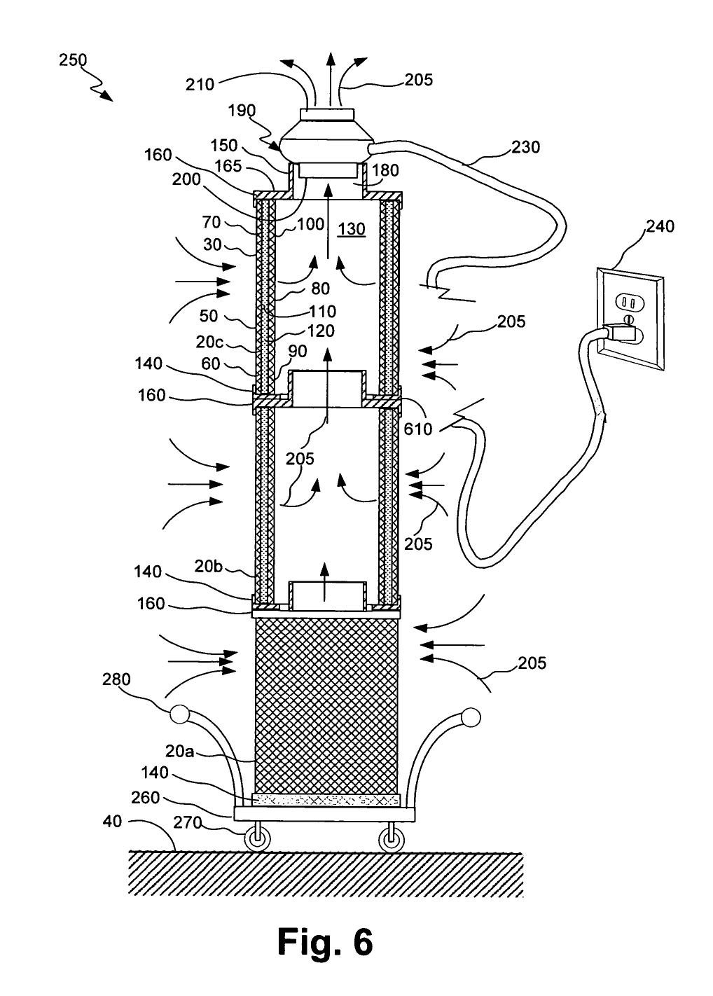

As best seen in FIG. 6, there is shown a second embodiment segmented stackable filter assembly, generally referred to as 250 (hereinafter “stackable filter assembly 250”), for filtering a gas, such as indoor room air. Stackable filter assembly 250 is provided with means for conveniently transporting column 30 thereof from one location to another location, such as from one room to another room of a business establishment, residence or any confined space needing air filtration. In this regard, stackable filter assembly 250 is substantially similar to stackable filter assembly 10, except a wheeled platform 260 is provided for moving column 30 of filter segments 20a, 20b and 20c along surface 40 while column 30 is disposed on wheeled platform 260. Wheeled platform 260 includes a plurality of wheels 270 (only two of which are shown) and an integrally attached handle 280 for manually moving wheeled platform 260 along surface 40.

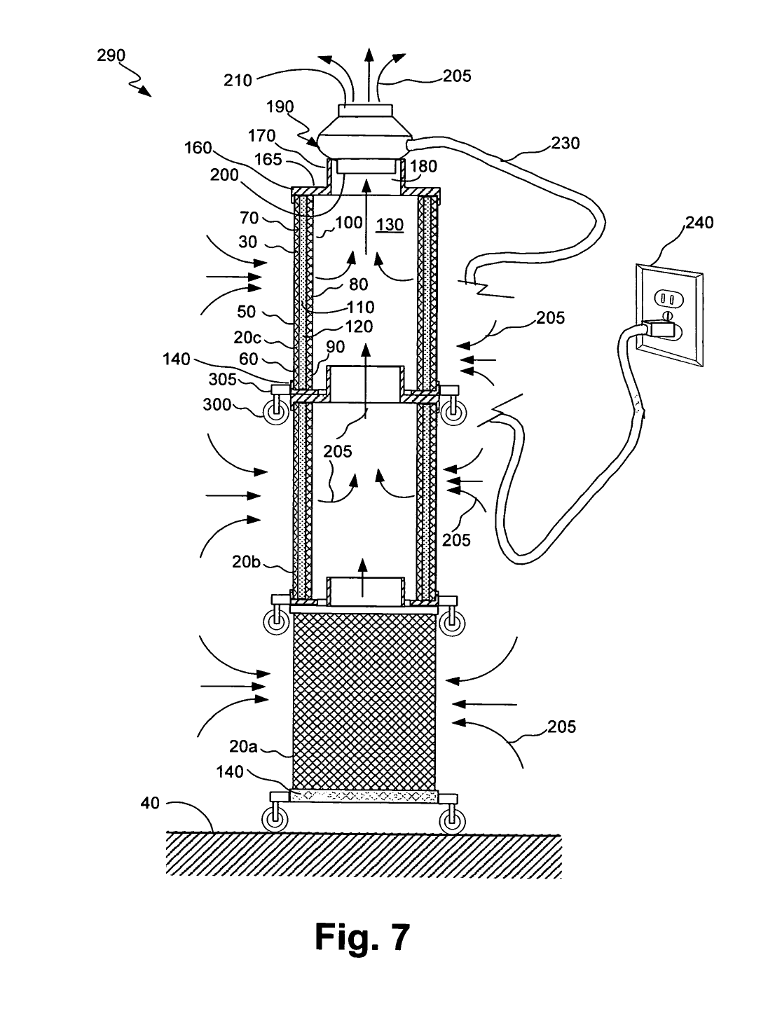

As seen in FIG. 7, there is shown a third embodiment segmented stackable filter assembly, generally referred to as 290 (hereinafter “stackable filter assembly 290”), for filtering a gas, such as indoor room air. Stackable filter assembly 290 is provided with means for conveniently transporting individual ones of filter segments 20a, 20b and 20c from one location to another location, such as from one room to another room of a business establishment, residence or any confined space needing air filtration. In this regard, stackable filter assembly 290 is substantially similar to stackable filter assembly 10, except each filter segment 20a, 20b and 20c is provided with a plurality of wheels 400 (only two of which are shown on each filter segment) connected to each lower end plate 140, such as by an outwardly extending bracket 405, for individually transporting filter segments 20a, 20b and 20c along surface 40.

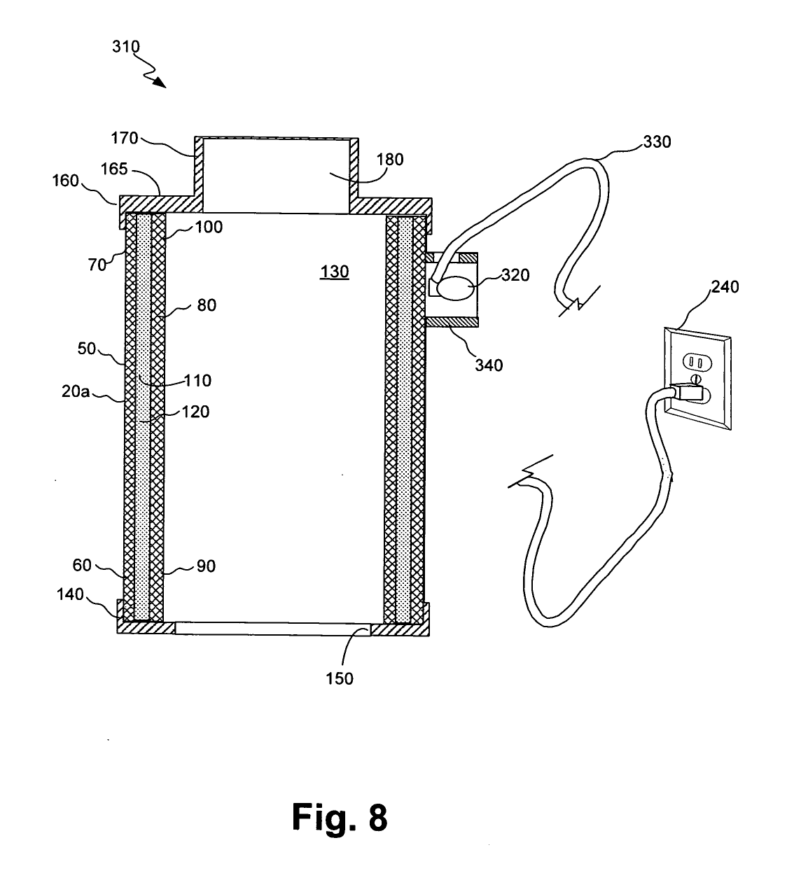

Referring to FIG. 8, there is shown a fourth embodiment segmented stackable filter assembly, generally referred to as 410 (hereinafter “stackable filter assembly 410”), for filtering a gas, such as indoor room air. Stackable filter assembly 410 is substantially similar to stackable filter assembly 10, except at least one ultraviolet light source 320 is provided for eliminating odors by generating a limited amount of ozone (O₃) to oxidize the odors, such that carbon dioxide (CO₂) and oxygen (O) are produced. Ultraviolet light source 320 is attached to an exterior surface of outer wire mesh 50 by any convenient means, such as by one or more weldments (not shown) when outer wire mesh 50 is metal, by a suitable adhesive (not shown) when outer wire mesh 50 is a plastic or composite, or by screws (also not shown). Ultraviolet light source 320, which may be an ultraviolet light bulb, is electrically connected by a electricity conducting wire 330 to previously mentioned electrical wall outlet 240, so that ultraviolet light source 320 is electrically energized thereby to produce ultraviolet light. In this configuration, the ultraviolet light will outwardly radiate into the room where stackable filter assembly 310 is disposed in order to at least partially kill microorgnisms in the room. Radially surrounding ultraviolet light source 320 and connected to the exterior surface of outer wire mesh 50, is a shroud 340 that is transparent to the ultraviolet light radiating from ultraviolet light source 320. Shroud 340 has a dual purpose. First, shroud 340 protects ultraviolet light source 320 from damage by nearby objects, such as furniture or equipment located near stackable filter assembly 310. Secondly, shroud 340, with a coating of a suitable catalyst material, such as titanium dioxide (TiO₂), will at least partially deodorize and sterilize room air by oxidation.

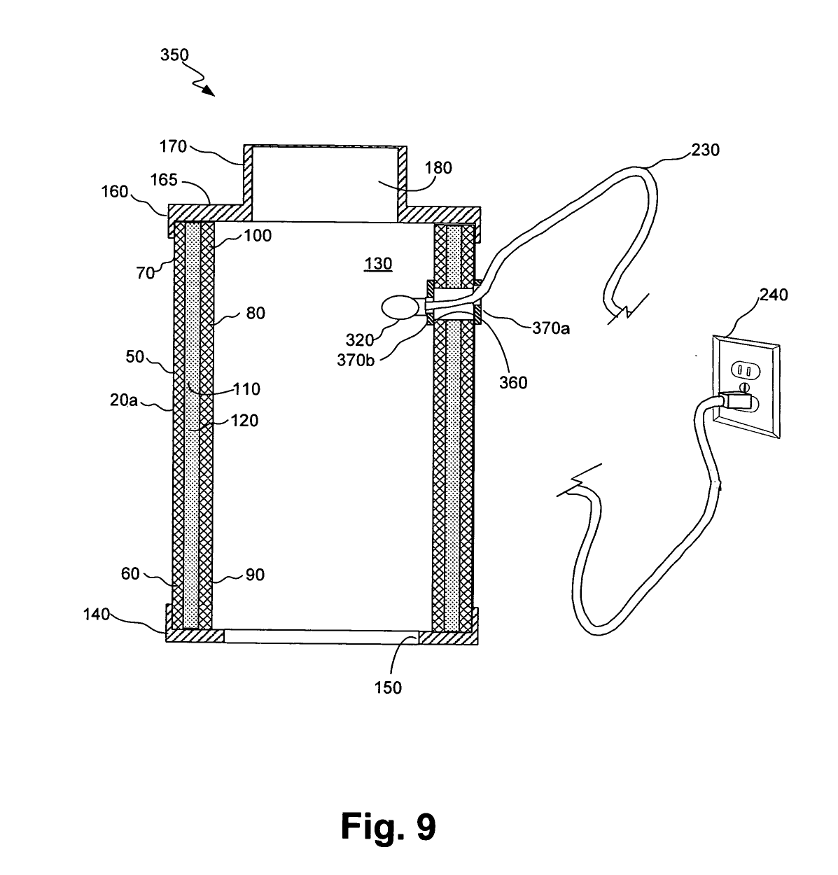

Referring to FIG. 9, there is shown a fifth embodiment segmented stackable filter assembly, generally referred to as 350 (hereinafter “stackable filter assembly 350”), for filtering a gas, such as indoor room air. Stackable filter assembly 350 is substantially similar to stackable filter assembly 310, except ultraviolet light source 320 is attached to an inner surface of inner wire mesh 80 by any convenient means, such as by one or more weldments (not shown) when inner wire mesh 80 is metal, by a suitable adhesive (not shown) when inner wire mesh 80 is a plastic or composite, or by screws (also not shown). Ultraviolet light source 320 is connected by electricity conducting wire 330 to previously mentioned electrical wall outlet 240. Electricity conducting wire 330 extends through a channel 360 formed through outer wire mesh 50, filter media 120 and inner wire mesh 80. Channel 360 is sealed against air passing therethrough by means of an exterior elastomeric seal 370a and an interior elastomeric seal 370b. In this configuration, interior seal 370b, which may be coated with previously mentioned titanium dioxide, may be connected to the inner surface of inner wire mesh 80 for at least partially deodorizing and sterilizing by oxidation air present in air flow passage 130. Disposing ultraviolet light source 320 on the inner surface of inner wire mesh 80 increases efficiency of contaminant removal by allowing ultraviolet light source 320 to act on air in the smaller volume of air flow passage 130, the air having been already filtered by the activated carbon filter media 120, rather than acting on the much larger volume of room air surrounding the filter segment and that has not been already filtered by the activated carbon filter media 120. At least one of filter segments 20a, 20b and 20c has ultraviolet light source 320 attached thereto. Alternatively, any of filter segments 20a/20b/20c may have more than one ultraviolet light source 320 attached thereto.

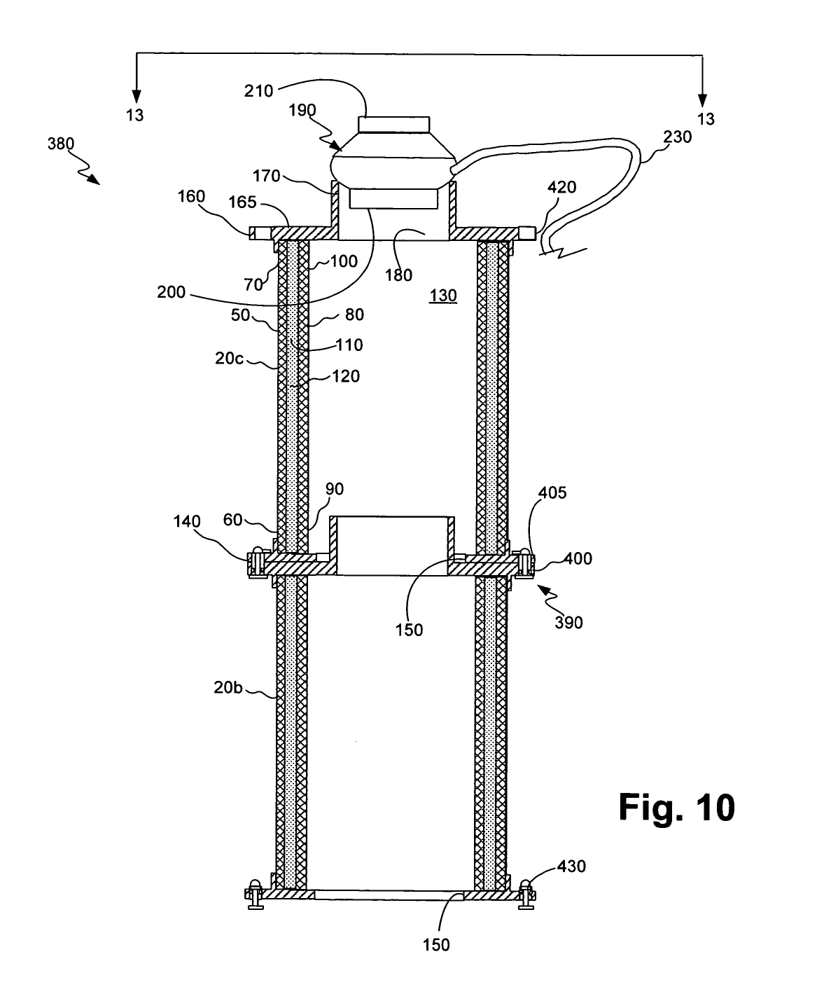

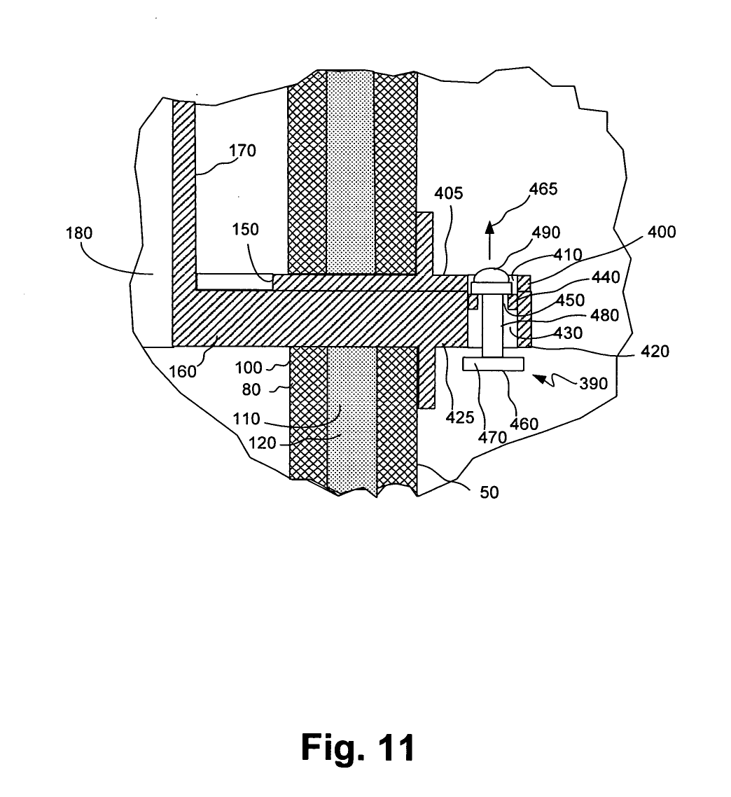

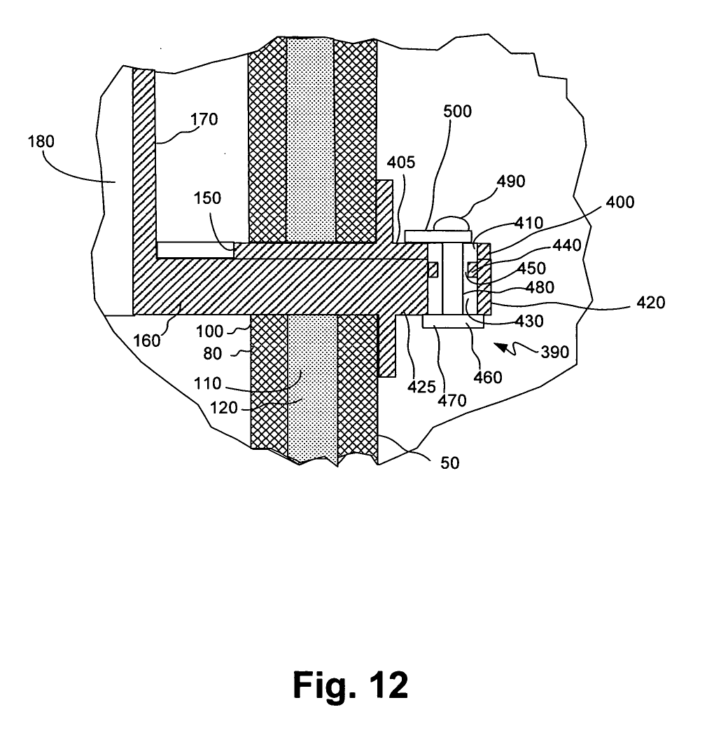

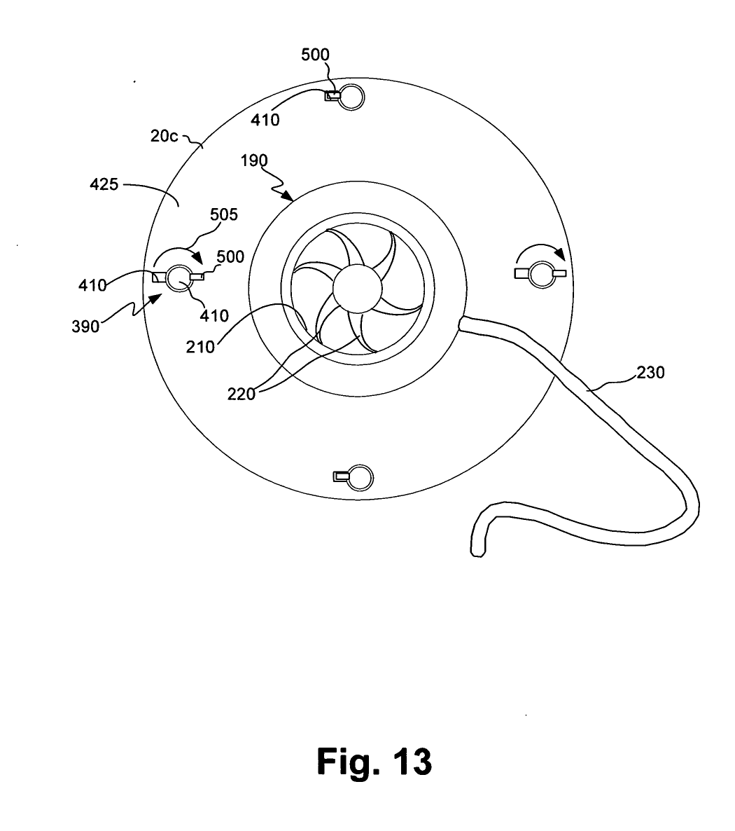

In FIGS. 10, 11, 12 and 13, a sixth embodiment segmented stackable filter assembly is there shown, generally referred to as 380 (hereinafter “stackable filter assembly 380”), for filtering a gas, such as indoor room air. Stackable filter assembly 380 is substantially similar to stackable filter assembly 10, except a fastener arrangement 390 is provided for releasably interlocking adjacent filter segments together, such as filter segments 20a and 20b. More specifically, lower end plate 140 includes a lower flange 400 therearound and integrally connected thereto. Lower flange 400 has an upper surface 405. Formed in lower flange 400 is a recess 410 for reasons provided presently. Upper end plate 160 includes an upper flange 420 therearound and integrally connected thereto. Upper flange 420 has an underside surface 425 for reasons provided hereinbelow. Formed through upper flange 420 is a hole 430 alignable with recess 410, for reasons provided momentarily. Positioned in hole 430 is a ledge 440 defining a bore 450 through ledge 440. A clamp member 460 includes a foot member 470 surrounding a first end portion of a shaft 480 and integrally connected thereto. Foot member 470 is sized to abut against underside surface 425. Shaft 480 extends through hole 430 and bore 450 to reside in recess 410. Shaft 480 comprises a shaft head 490 including an integrally attached arm 500 outwardly extending therefrom. Arm 500 is shaped to be matingly received in recess 410 and rest on ledge 440.

Still referring to FIGS. 10, 11, 12 and 13, the manner in which adjacent filter segments, such as filter segments 20a and 20b, are releasably interlocked will now described. In this regard, the user of stackable filter assembly 380 mounts filter segment 20b on filter segment 20a such that each recess 410 is aligned with respective ones of holes 430 and bores 450. Foot member 460 is then upwardly, manually pushed in the direction of an arrow 465 for allowing shaft 480 to upwardly travel in bore 450. As shaft 480 travels in bore 450, arm 500 will be released from recess 410 and will disengage from ledge 440. Arm 500 is then manually rotated, such as in the direction of an arrow 505, by the user of stackable filter assembly 380. The user then stops pushing foot member 470. When the user stops pushing foot member 470, arm 500 will then drop or descend to rest on upper surface 405 of lower flange 420. The adjacent filter segments, such as filter segment 20a and filter segment 20b, are properly interlocked as all arms 500 come to rest on upper surface 405 of lower flange 420. The adjacent filter segments are unlocked by performing the above procedure in reverse. Thus, it should be appreciated that, based on the description hereinabove, use of clamp fastener arrangement 390 not only prevents lateral movement of one filter segment relative to an adjacent filter segment, but also prevents vertical movement of the one filter segment relative to the adjacent filter segment. In this manner, column 30 of filter segments 20a, 20b and 20c acquires enhanced stability and resistance to undesired separation even when inadvertently “bumped” or otherwise unintentionally disturbed.

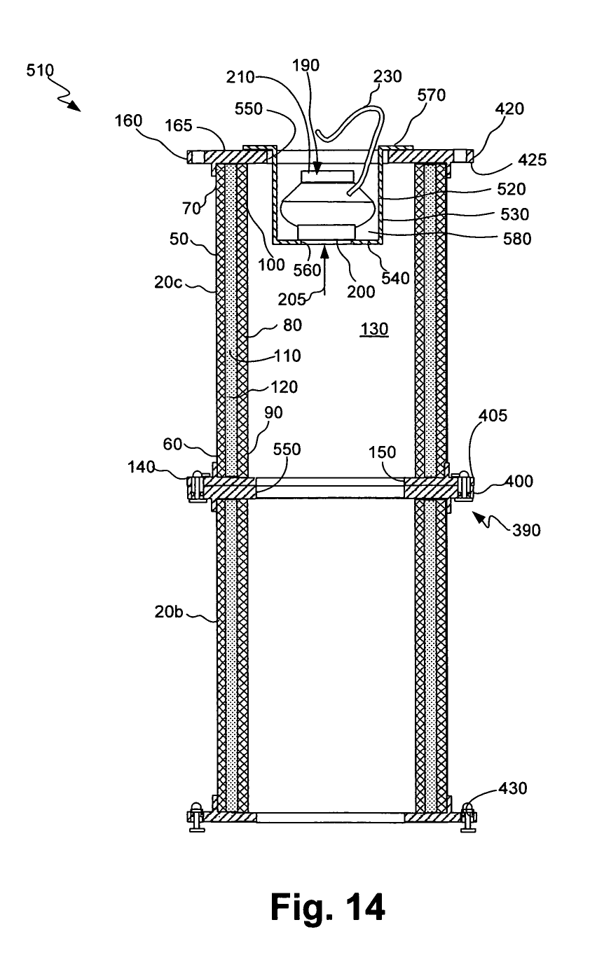

In FIG. 14, a seventh embodiment segmented stackable filter assembly, generally referred to as 510 (hereinafter “stackable filter assembly 510”), is provided for filtering a gas, such as indoor room air. Stackable filter assembly 510 is substantially similar to stackable filter assembly 380, except a removable fan assembly support 520 is provided for supporting fan assembly 190 in an uppermost filter segment, such as filter segment 20c. More specifically, as previously mentioned, clamp fastener arrangement 390 prevents inadvertent lateral and vertical movement of filter segments 20a. 20b and 20c relative to each other. Therefore, neck portion 170 is not required for preventing inadvertent lateral movement of filter segments 20a, 20b and 20c relative to each and can be eliminated. Elimination of neck portion 170 in each filter segment reduces the manufacturing and material costs associated with providing neck portion 170. However, elimination of neck portion 170 requires an alternative means for supporting fan assembly 190 in an uppermost filter segment, such as filter segment 20c. Therefore, removable fan assembly support 520 is provided for supporting fan assembly 190 in the uppermost filter segment, such as filter segment 20c. The fan assembly support 520 is generally cylindrical shaped, box-shaped or any convenient shape and is sized to be inserted through an opening 550 formed through upper end plate 160. Fan assembly support 520 comprises an upright wall 530 integrally connected to a base 540 that has a hole 560. Fan assembly support 520 also includes an annular flange 570, or a plurality of support legs (not shown), at an upper portion of fan assembly support 520. Annular flange 570 engages previously mentioned upper surface 165 of upper end plate 160. Alternatively, fan assembly support 520 may comprise a plurality of upright support legs (not shown) engaging upper surface 165 of upper end plate 160 rather than comprising annular flange 570, if desired. Fan assembly support 520 defines an inner volume 580 therein for receiving fan assembly 190 which is sized to pass through opening 550 and into inner volume 580. Fan assembly 190 is disposed in inner volume 580 such that air intake 200 is aligned with hole 560. In this manner, when fan assembly 190 is operated, air is drawn or suctioned through air flow passage 130, through hole 560, through air intake 200 and out exhaust 210. When desired, fan assembly 190 and the accompanying fan assembly support 520 can be removed by lifting fan assembly support 520 outwardly through opening 550.

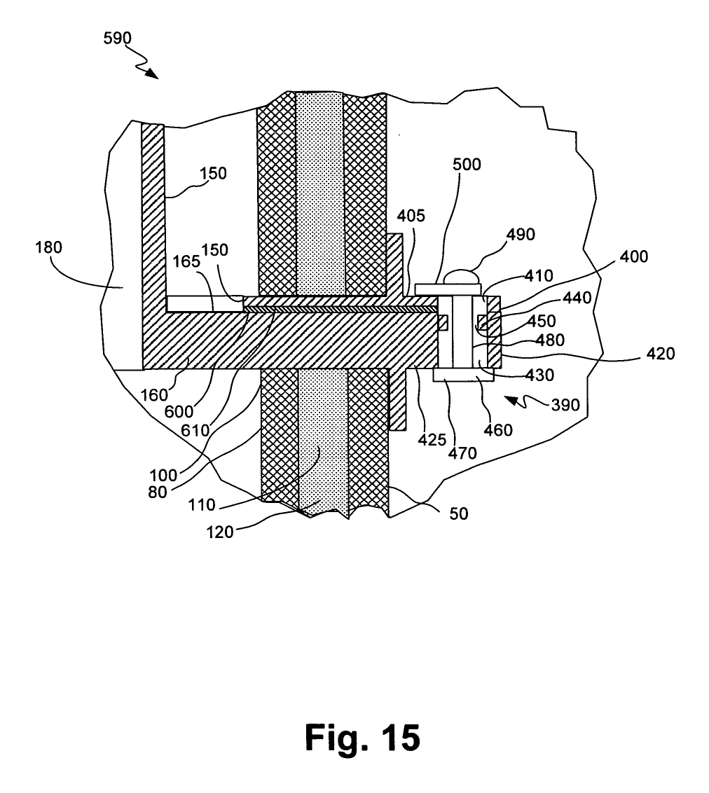

Turning to FIG. 15, an eighth embodiment segmented stackable filter assembly, generally referred to as 590 (hereinafter “stackable filter assembly 590”), is provided for filtering a gas, such as indoor room air. More specifically, deployed in combination with any of the fastener arrangements described herein, such as clamp fastener arrangement 390, is an optional annular gasket or seal 600 that encircles neck portion 150 and that is attached to upper surface 165 of upper end plate 160. Seal 600 may be manufactured from a resilient elastomeric material such as rubber. Seal 600 serves a dual purpose. First, seal 600 seals an interface 610 between adjacent filter segments. Sealing interface 610 ensures air enters air flow passage 130 only through filter media 120, rather than through interface 610, so that the air flow entering the air passage 130 does not bypass filter media 120 in order that the air is efficiently filtered thereby. Secondly, elastomeric seal 600 also reduces noise and vibration in stackable filter assembly 590 while fan assembly 190 is operated.

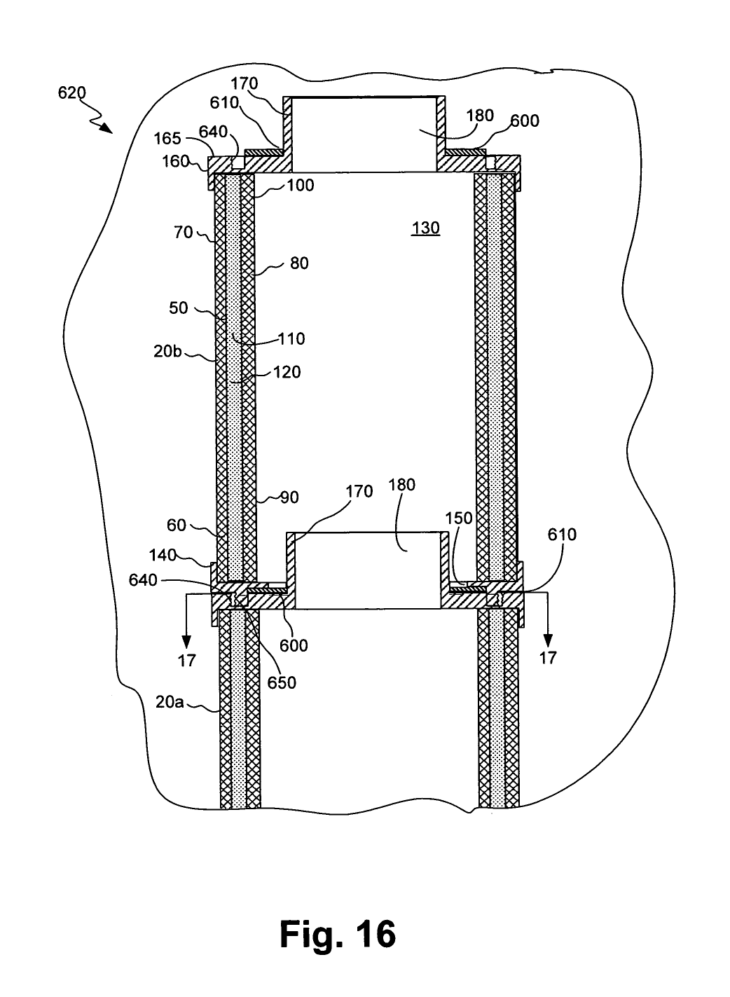

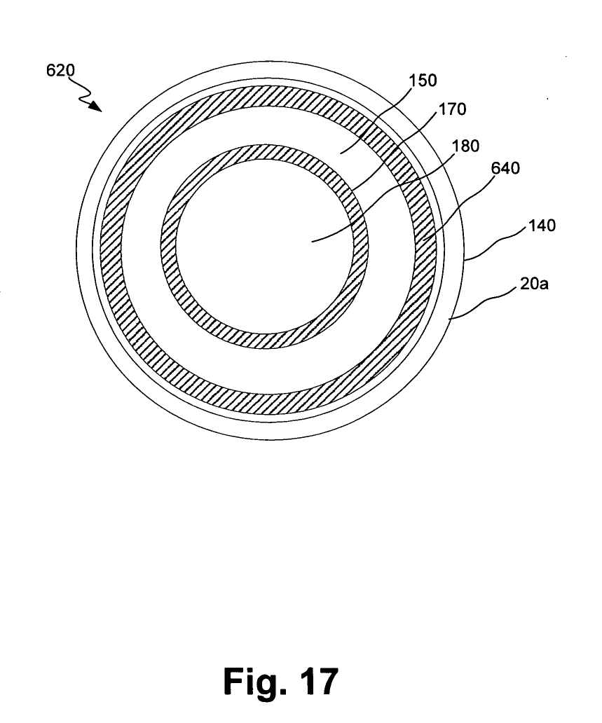

With reference to FIGS. 16 and 17, a ninth embodiment segmented stackable filter assembly is there shown, generally referred to a 620 (hereinafter “stackable filter assembly 620”), for filtering a gas, such as indoor room air. Stackable filter assembly 620 comprises a first threaded fastener arrangement 630 that is provided for releasably interlocking adjacent filter segments together, such as filter segments 20a and 20b. More specifically, each upper end plate 160 defines a circular, internally threaded female bore 640 sized to threadably engage a mating, externally threaded male projection 650 that outwardly extends from lower end plate 140. In order to interlock adjacent filter segments, such as filter segments 20a and 20b, threaded male projection 650 is inserted into threaded female bore 640 and threadably engaged with threaded female bore 640 by rotating threaded male projection 650 within threaded female bore 640 until the filter segments are sufficiently interlocked. In this regard, externally threaded male protection 650 is caused to threadably engage internally threaded female bore 640 by rotating one filter segment relative to an adjacent filter segment until the filter segments are sufficiently threadably interlocked. The interlocking process is reversed in order to unlock adjacent filter segments.

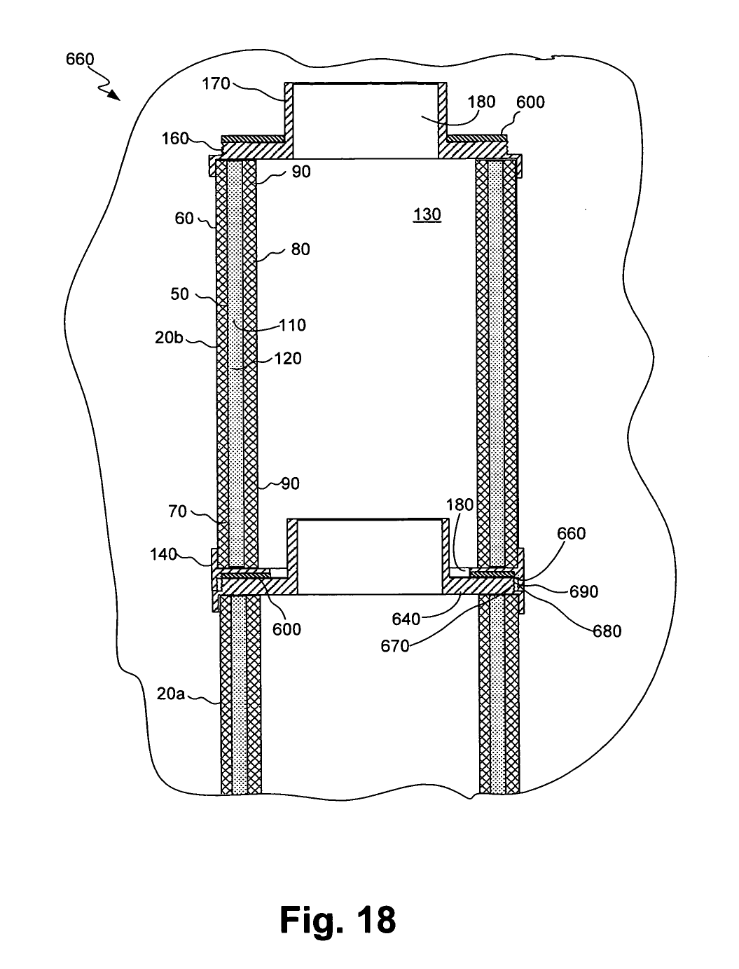

Referring to FIG. 18, a tenth embodiment segmented stackable filter assembly is there shown, generally referred to a 660 (hereinafter “stackable filter assembly 660”), for filtering a gas, such as indoor room air. Stackable filter assembly 660 is substantially similar to ninth embodiment stackable assembly 620, except a second embodiment threaded fastener arrangement 670 is provided for releasably interlocking adjacent filter segments together, such as filter segments 20a and 20b. More specifically, each upper end plate 160 defines a circular, externally threaded surface 680 for threadably engaging a mating, internally threaded bore 690 formed in lower end plate 140. In order to interlock adjacent filter segments, such as filter segments 20a and 20b, internally threaded bore 690 is caused to surround externally threaded surface 680. In this regard, internally threaded bore 690 is caused to threadably engage externally threaded surface 680 by rotating one filter segment relative to an adjacent filter segment until the filter segments are sufficiently threadably interlocked. The interlocking process is reversed in order to unlock adjacent filter segments.

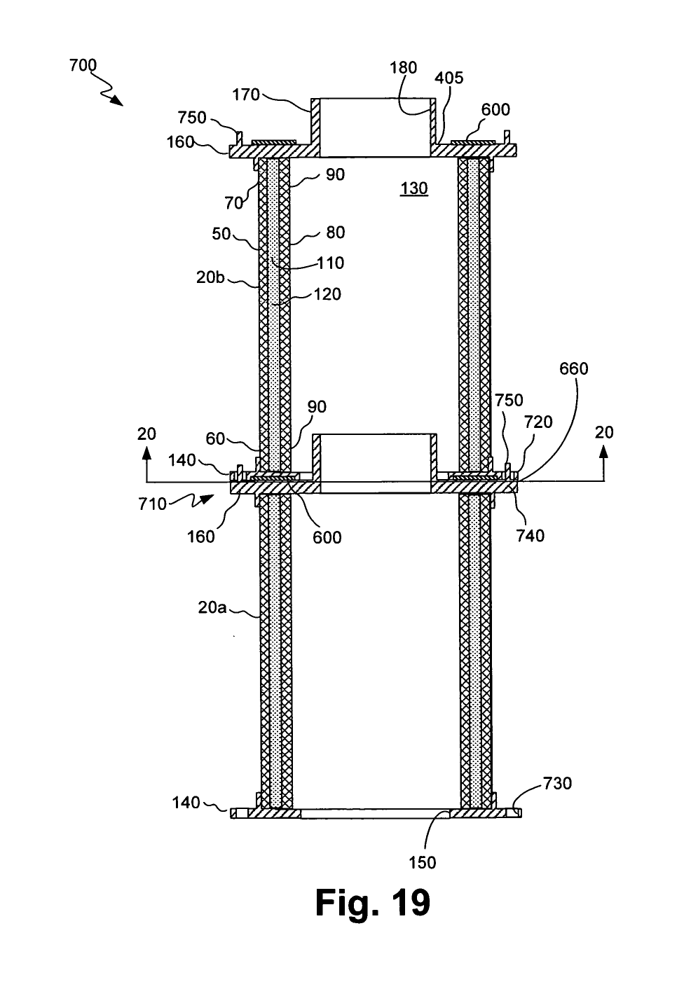

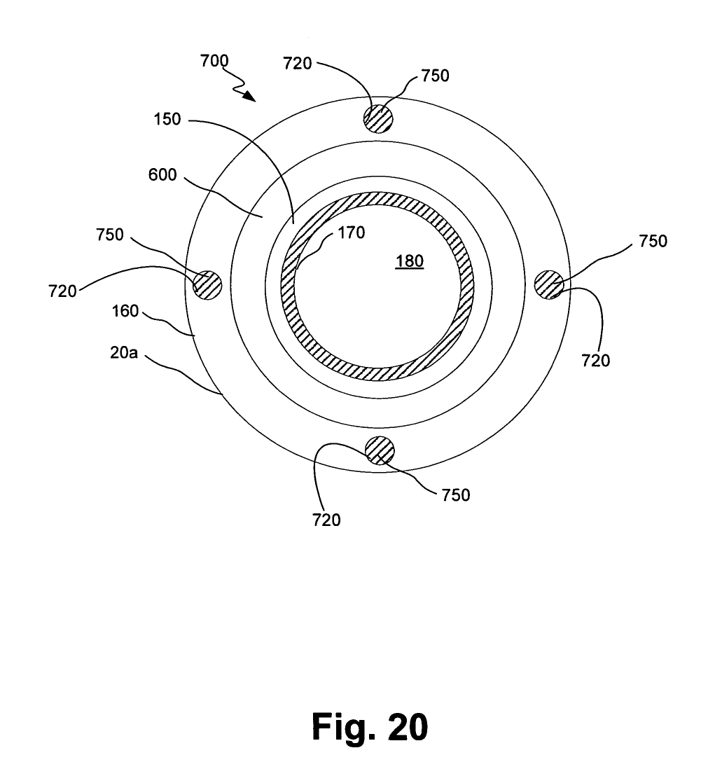

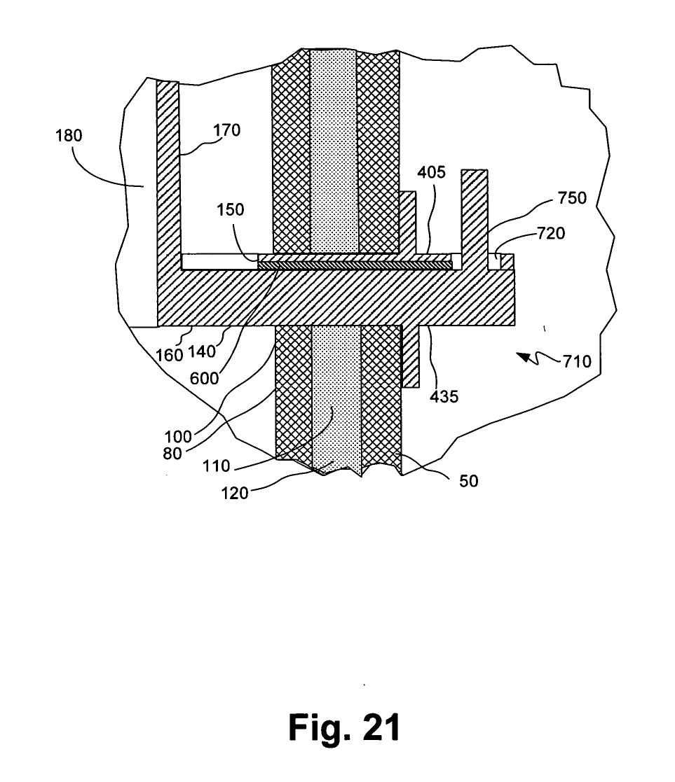

Referring to FIGS. 19, 20 and 21, an eleventh embodiment segmented stackable filter assembly is there shown, generally referred to a 700 (hereinafter “stackable filter assembly 700”), for filtering a gas, such as indoor room air. Stackable filter assembly 700 comprises a pin fastener arrangement 710 for releasably interlocking adjacent filter segments together, such as filter segments 20a and 20b. More specifically, lower end plate 140 includes a first flange portion 720 therearound having a plurality of spaced-apart bores 730 formed therethrough. Upper end plate 160 has a second flange portion 740 having a plurality of outwardly projecting pins 750 sized to engage respective ones of bores 730. Lateral movement of the filter segments, such as filter segments 20a and 20b, relative to each other is prevented while pins 750 are received in bores 730. In this manner, column 30 of filter segments 20a, 20b and 20c acquires enhanced stability and resistance to undesired separation even when inadvertently “bumped” or otherwise unintentionally disturbed.

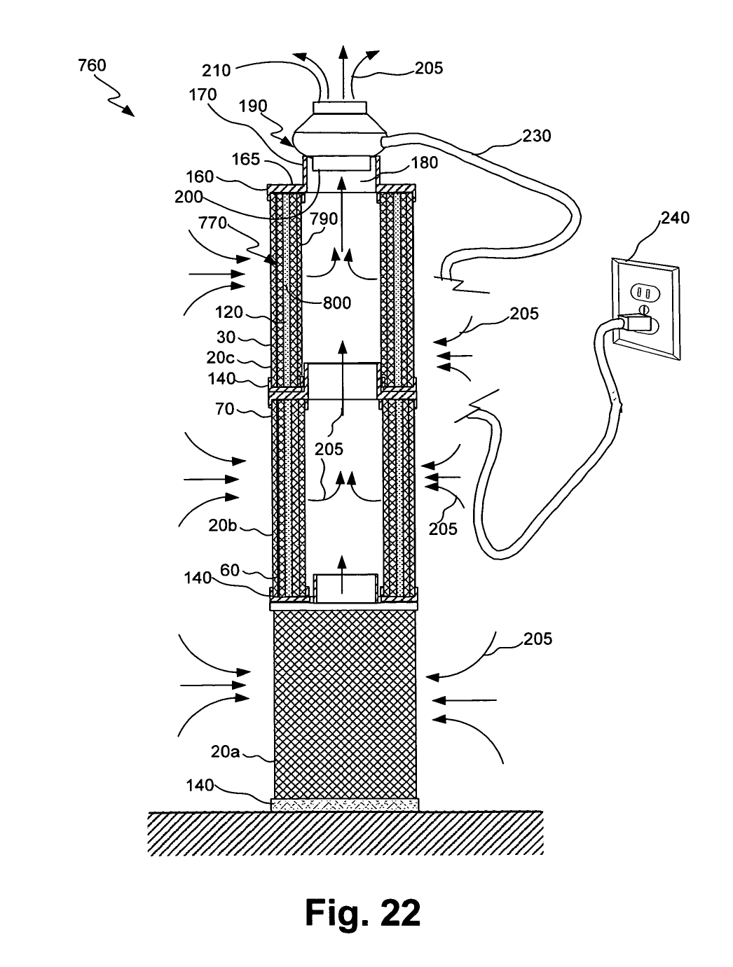

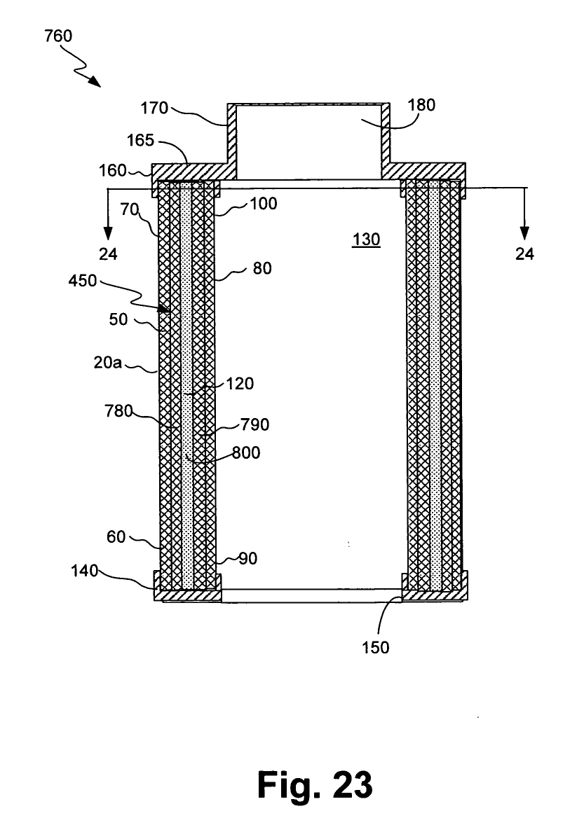

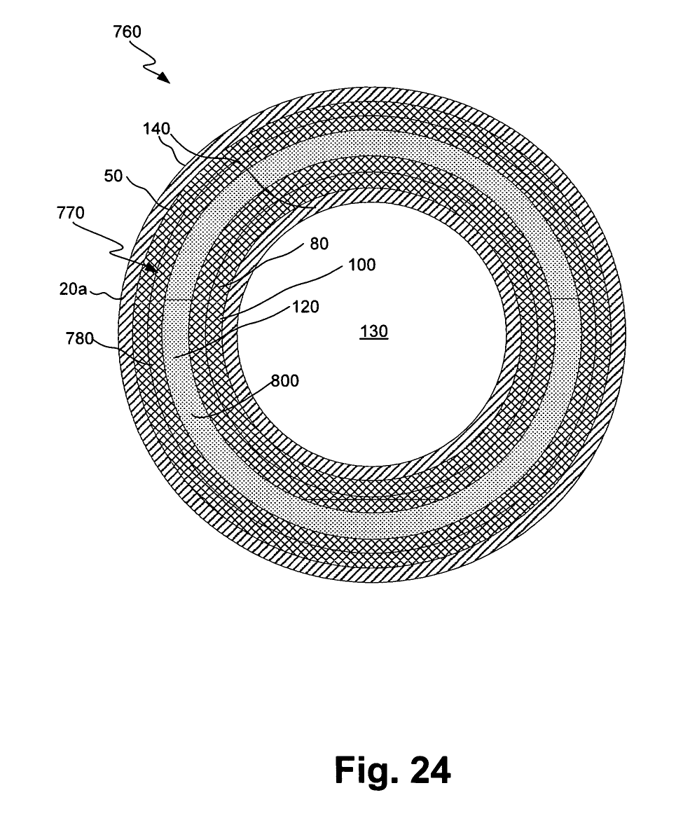

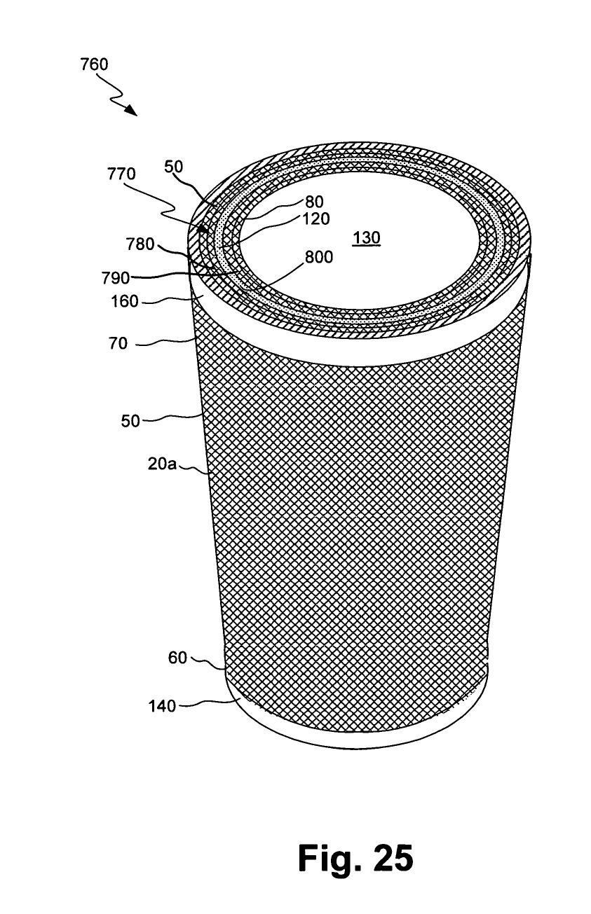

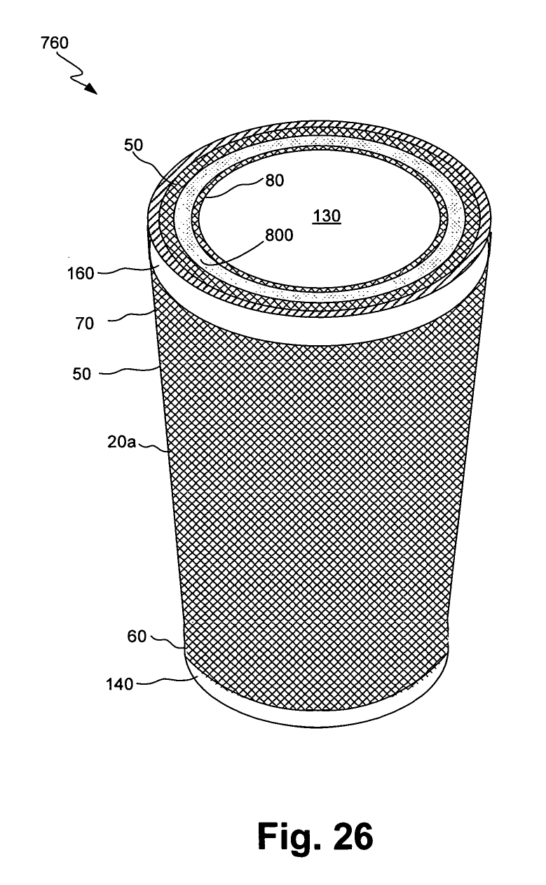

FIGS. 22, 23, 24, 25 and 26 show a twelfth embodiment segmented stackable filter assembly, generally referred to a 760 (hereinafter “stackable filter assembly 760”), for filtering a gas, such as indoor room air. Each filter segment 20a, 20b and 20c of stackable filter assembly 760 includes an annular filter cassette, generally referred to as 770. Filter cassette 770 is disposed in previously mentioned gap 110 that is defined between first wire mesh 50 and second wire mesh 80. In this embodiment, gap 110 is sized to accommodate filter cassette 770. Filter cassette 770 includes an annular third wire mesh 780 and an annular fourth wire mesh 790 disposed inwardly of third wire mesh 460, so as to define an annular space 800 therebetween that is filled with filter media 120. A benefit of using stackable filter assembly 760 is that, when filter media 120 becomes depleted and ineffective for removing odors or other gaseous contaminants, filter cassette 770 may be removed and replaced with a fresh filter cassette 770. In order to allow removal and replacement of filter cassette 770, previously mentioned upper end plate 140 is detachable from the upper end portion 70 of each of filter segments 20a, 20b or 20c, rather than being welded to upper end portion 70 of first wire mesh 50 of each filter segment 20a, 20b or 20c. A tab (not shown) may be attached to an upper portion of filter cassette assembly 770 to assist in manually removing and replacing filter cassette 770.

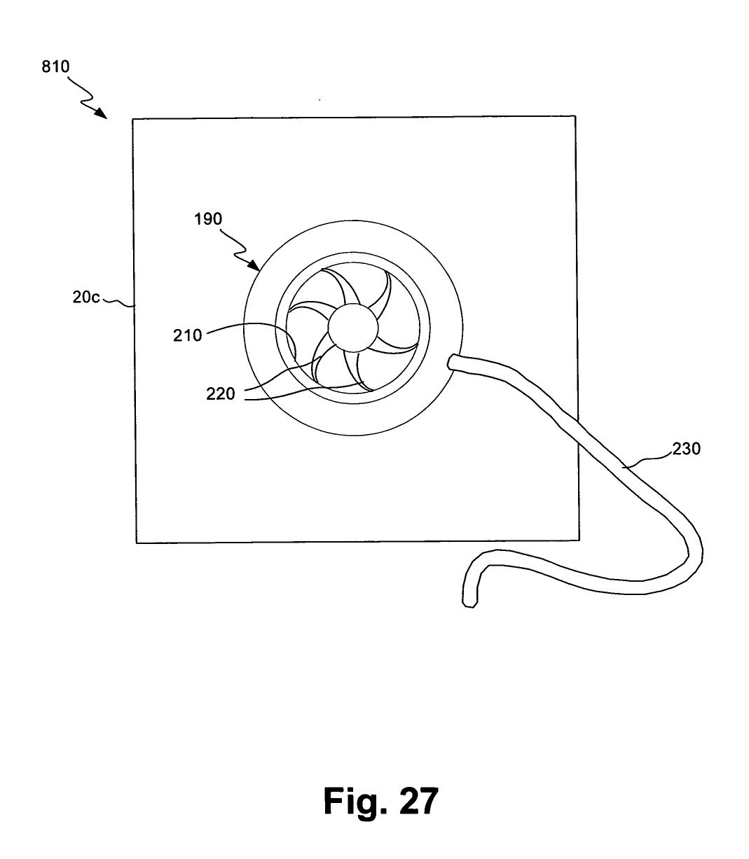

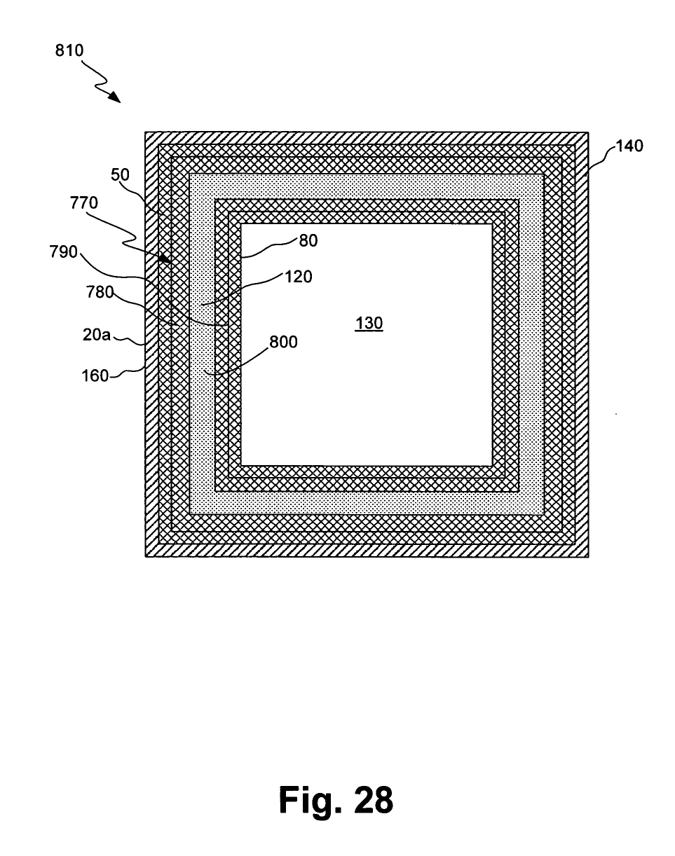

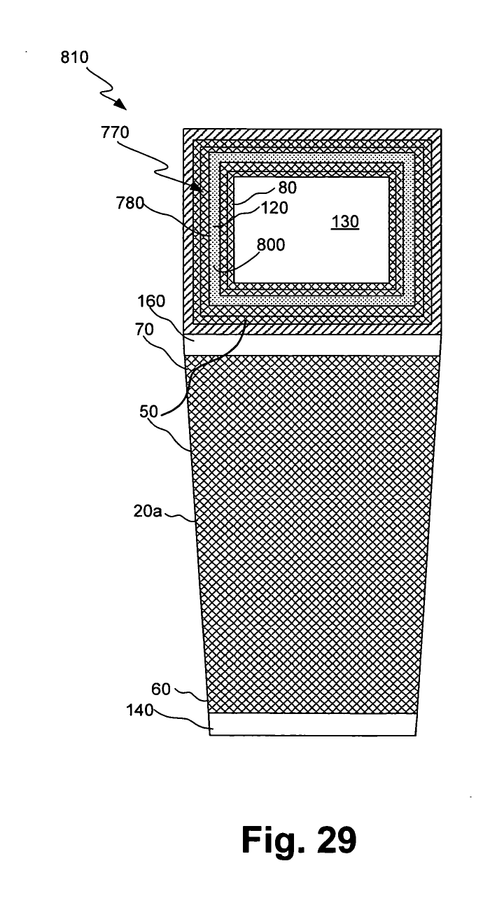

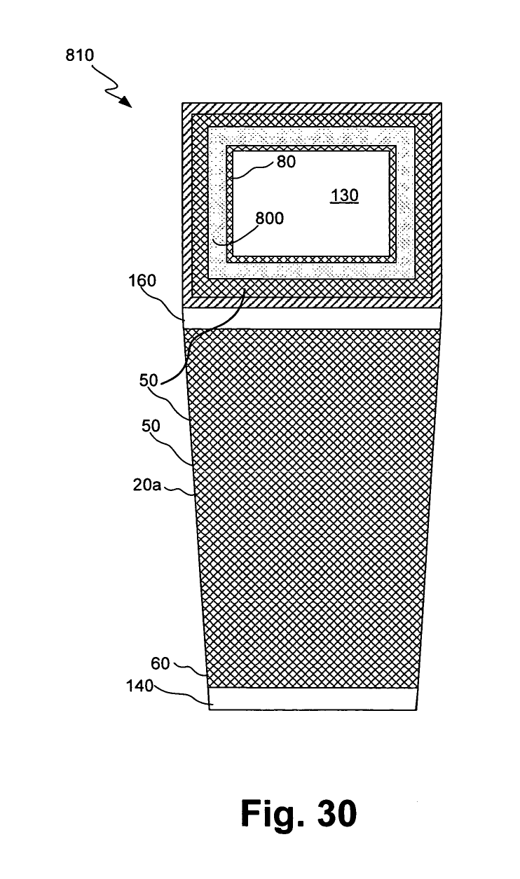

FIGS. 27, 28, 29 and 30 show a thirteenth embodiment segmented stackable filter assembly, generally referred to a 810 (hereinafter “stackable filter assembly 810”), for filtering a gas, such as indoor room air. Stackable filter assembly 810 is substantially similar to stackable filter assembly 760, except stackable filter assembly 810 is parallelpiped-shaped rather than cylindrically-shaped for convenient placement in a space having a square or rectangular cross-section, such as an air duct in a business establishment, residence or any square or rectangular confined space needing air filtration.

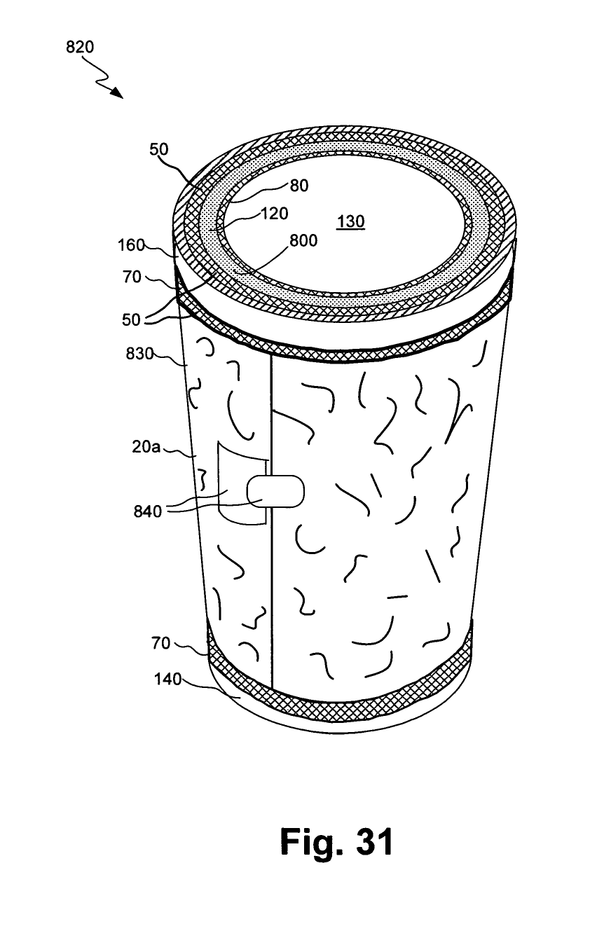

As best seen in FIG. 31, a fourteenth embodiment segmented stackable filter assembly, generally referred to as 820 (hereinafter “stackable filter assembly 820”), is there shown for filtering a gas, such as indoor room air, and for simultaneously filtering air-borne particulate matter from the air. Stackable filter assembly 820 is substantially similar to stackable filter assembly 760, except stackable filter assembly 820 includes a removable or replaceable prefilter shroud 830. However, based on applicant's teachings, it should be appreciated by a person of ordinary skill in the art of air filter design that any of the embodiments of the segmented stackable filter assembly disclosed herein may be provided with prefilter shroud 830. The cylindrically-shaped stackable filter assembly 820 illustrated in the figure is intended to be exemplary only and not limiting. In other words, prefilter shroud 830 may be used with any suitable shape of stackable filter assembly. Prefilter shroud 830 is formed from a microporous, flexible material that can be individually wrapped around one or more of the filter segments, such as filter segment 20a, for prefiltering air entering the filter segment through first wire mesh 50. Prefilter shroud 830 is capable of capturing dust, lint, asbestos fibers, pet dander and other particulate matter. In this regard, the prefilter material may be any suitable prefilter material, such as paper, polyester or glass needled punch fibers, or any suitable synthetic foam material. Prefilter shroud 830 serves a dual purpose. First, prefilter shroud 830 may include a multiplicity of activated carbon particles (not shown) for removing unwanted odors from the air entering filter segment 20a. Secondly, prefilter shroud 830 may primarily be made from foam for removing larger particulates in addition to smaller particulates from the air entering filter segment 20a. Prefiltering air in this manner may increase efficiency of removal of contaminants from the air by filtering the air before the air enters filter media 120. Prefilter shroud 830 may be held in place by any convenient means, such as by means of hook-and-loop fasteners 840 that may be VELCRO®brand fasteners. VELCRO® is a registered trademark of Velcro Industries, B.V. located in Amsterdam, The Netherlands.

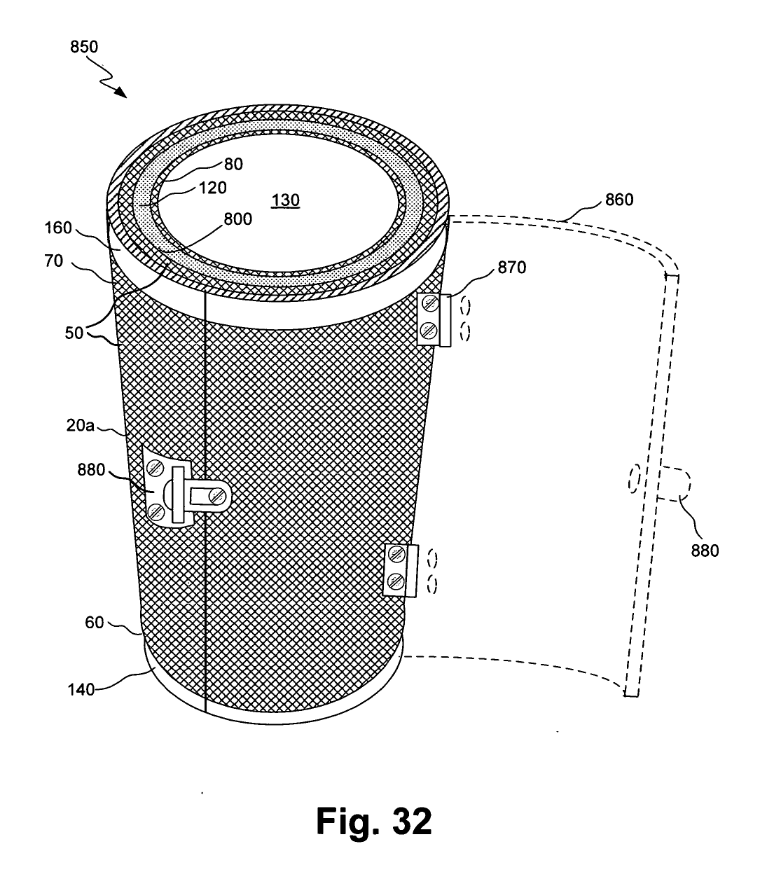

Referring to FIG. 32, a fifteenth embodiment segmented stackable filter assembly, generally referred to as 850 (hereinafter “stackable filter assembly 850”), is there shown for filtering a gas, such as indoor room air. Stackable filter assembly 850 comprises a hinged door 860 connected to outer wire mesh 150 by means of at least one hinge 870. Hinged door 860 allows convenient access to previously mentioned replaceable filter cassette 770, so that filter cassette 770 can be replaced without removing upper end plate 160. Avoiding removal of upper end plate 160 avoids disassembly of column 30 in order to gain access to the filter cassette 770 in a particular filter segment, such as filter segment 20b, which is located between filter segments 20a and 20c. Hinged door 860 can be locked in a closed position by means of a suitable latch mechanism 880.

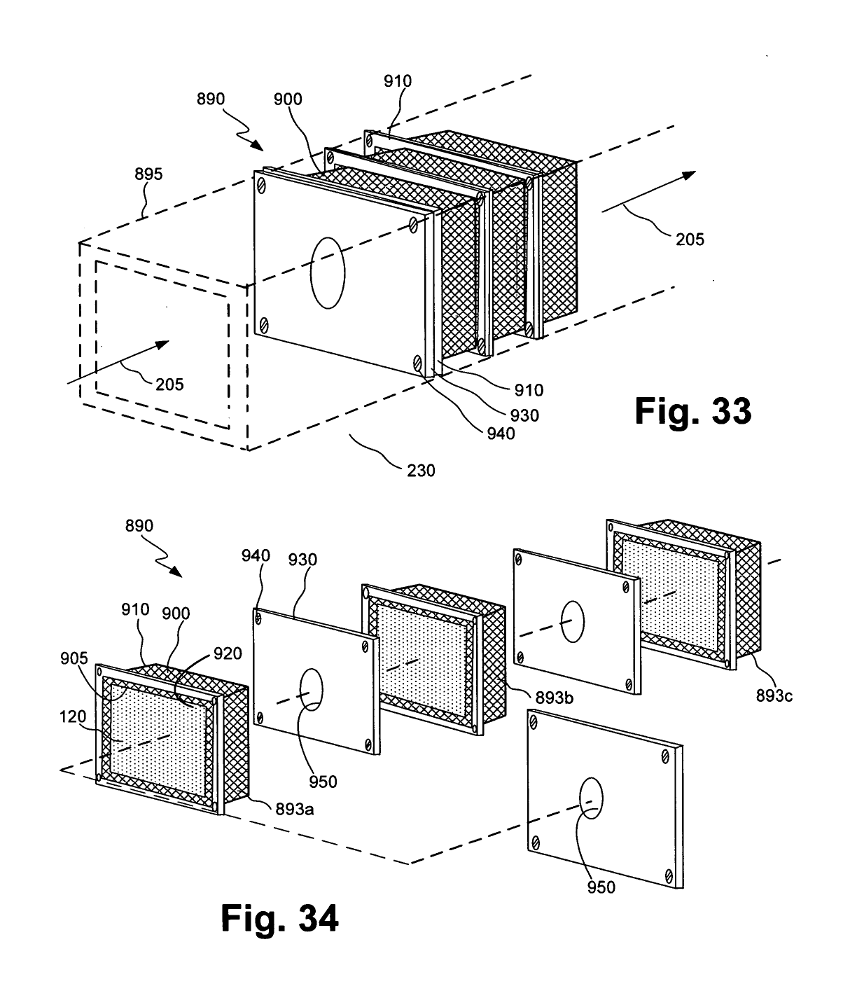

Referring to FIGS. 33 and 34, a sixteenth embodiment segmented stackable filter assembly, generally referred to as 890 (hereinafter “stackable filter assembly 890”), is there shown for filtering a gas, such as indoor room air. Stackable filter assembly 890 comprises a plurality of filter segments 893a, 893b and 893c. Stackable filter assembly 890 is shown horizontally oriented rather than vertically oriented and defines a parallelpiped envelope having a square or rectangular transverse cross-section. Stackable filter assembly 890 has a square or rectangular cross-section for placement in a square or rectangular space, such as an air duct 895 typically found in a business establishment, residence or other confined space needing air filtration. Stackable filter assembly 850 comprises a square-shaped or rectangularly-shaped wire mesh 900 defining an open end 905 and having an end portion thereof surrounded by a square-shaped or rectangularly-shaped flange 910. The square-shaped or rectangularly-shaped flange 910 is sized to matingly fit within air duct 895 in order to stabilized stackable filter assembly 890 against lateral and vertical movement when disposed in air duct 895. An inner volume 920 is filled with previously mentioned filter media 120 for filtering room air. A plate member 930 covers open end 905 and is connected to flange 910, such as by a plurality of screws 940. In addition, plate member 930 has an aperture 950 therethrough in communication with inner volume 920. Previously mentioned fan assembly 190 is not required and is not present. Fan assembly 190 is not required because duct fan (not shown) is typically already connected to air duct 895 to suction air through air duct 895. Presence of plate member 930 on each filter segment 893a, 893b and 893c allows each filter segment 893a, 893b and 893c to engage the walls of air duct 895 for stably disposing stackable filter assembly 890 within air duct 895. Also, presence of each plate member 930 in cooperation with each wire mesh 900 assists in maintaining filter media 120 confined within each filter segment 893a, 893b and 893c. As the duct fan is operated, room air will be suctioned and travel through stackable filter assembly 890 to be filtered thereby. The filtered air will thereafter travel downstream in air duct 895. Any air entering air duct 895 that bypasses plate members 930 will nonetheless be suctioned through wire mesh 900 and into filter media 120 for filtering. This is so because air flowing through filter media 120 due to operation of the duct fan will have a higher velocity than any air bypassing plate members 930. This higher velocity air will be at a lower pressure than air bypassing plate members 930. A pressure difference will be established that will draw-in or suction the air exterior to wire mesh 900, so that the exterior air enters filter media 120 through wire mesh 900. In addition, elastomeric seals (not shown) may be disposed in an interface between each plate member 900 and each flange 910 for sealing the interface and for abating vibration as air is suctioned through stackable filter assembly 890. Disposing stackable filter assembly 890 in air duct 895 may be desired by some users for aesthetic reasons because stackable filter assembly 890 is hidden from view and does not occupy space in the room having air to be filtered. In addition, the horizontal configuration of stackable filter assembly 890 provides stackable filter assembly 890 with a low profile. Providing stackable filter assembly 890 with a low profile allows stackable filter assembly 890 to be more readily disposed adjacent to ceiling structure. More specifically, stackable filter assembly 890 can be suspended from a ceiling by means of U-shaped brackets (not shown) and have the air filtered thereby exhausted to an intake of an air duct, if desired.

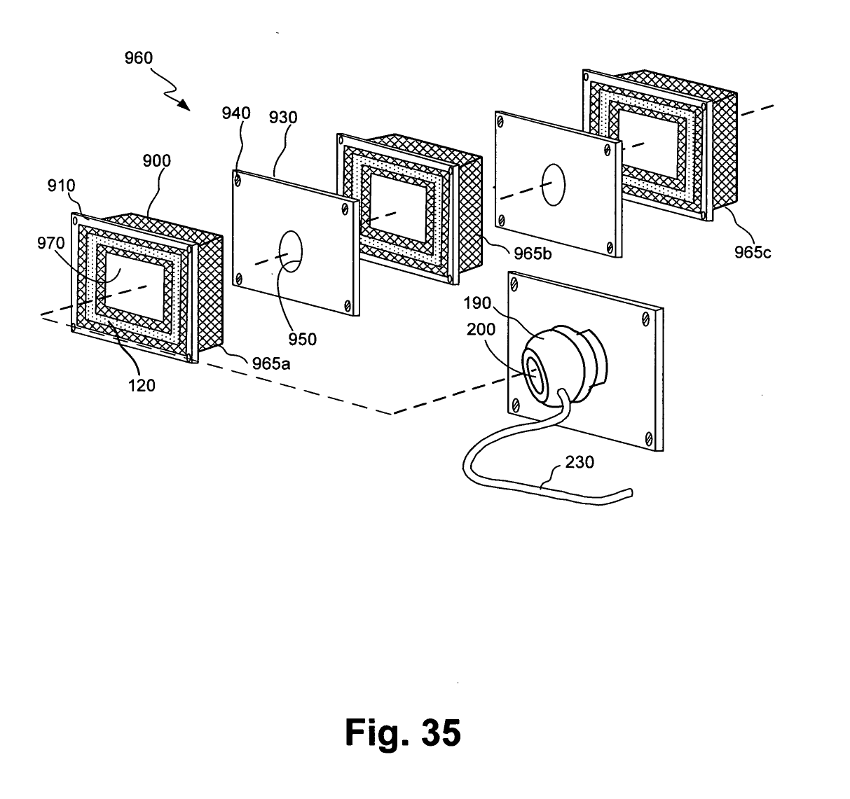

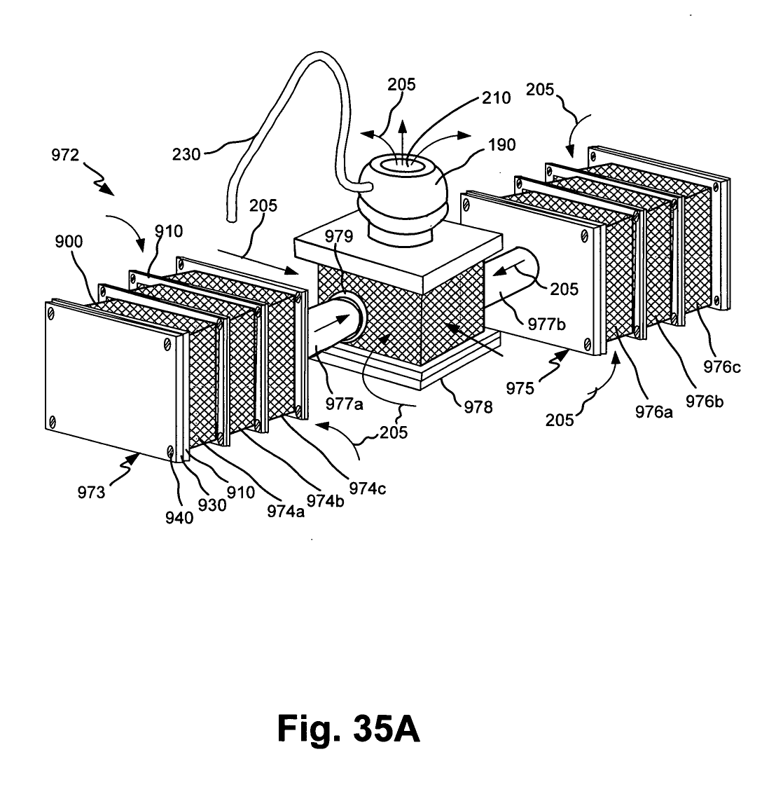

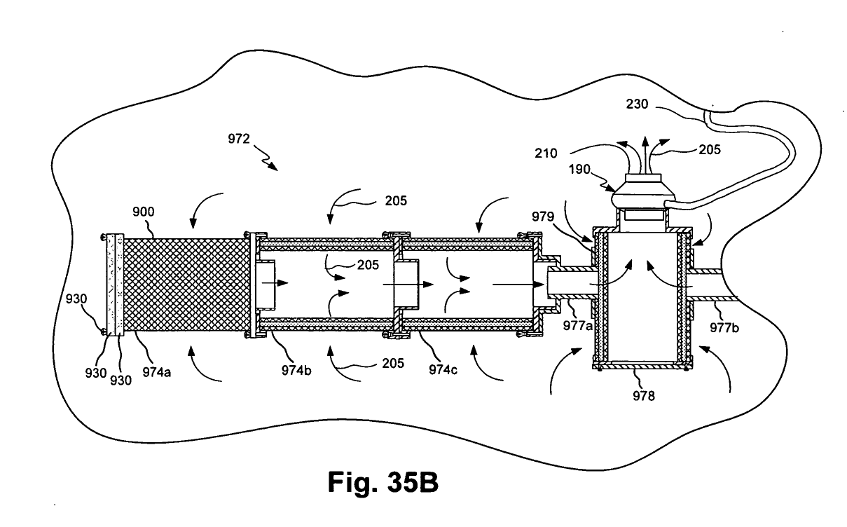

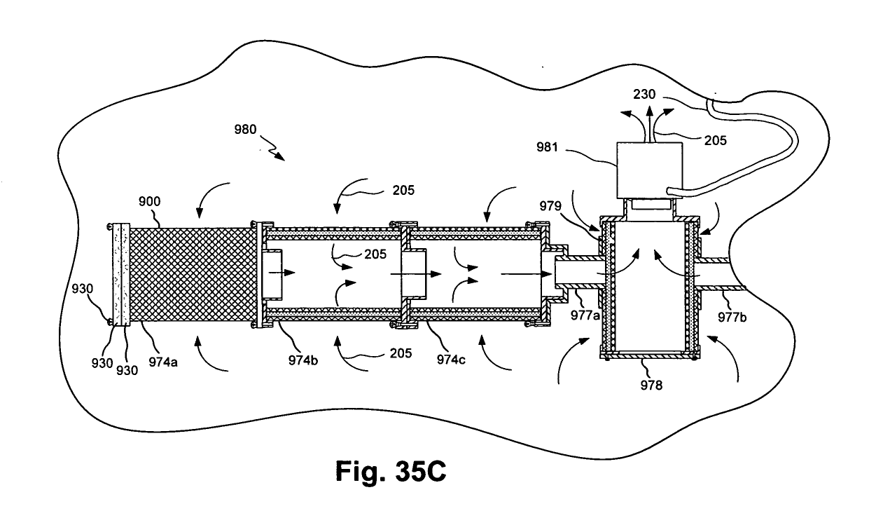

As seen in FIG. 35, a seventeenth embodiment segmented stackable filter assembly, generally referred to as 960 (hereinafter “stackable filter assembly 960”), is there shown for filtering a gas, such as indoor room air. Stackable filter assembly 960 comprises a plurality of aligned filter segments 965a, 965b and 965c. Stackable filter assembly 960 is substantially similar to stackable filter assembly 890, except an air flow channel 970 is centrally formed therethrough. Surrounding air flow channel 970 is previously mentioned filter media 120. Sizing the transverse cross-section of air flow channel 970 in combination with varying the volume of filter media 120 controls filtering capacity of stackable filter assembly 960. In other words, more filter media 120 is placeable within each filter segment 965a, 965b and 965c when the cross-sectional area of air flow channel 970 is reduced. Conversely, less filter media 120 is placeable within each filter segment 965a, 965b and 965c when the cross-sectional area of air flow channel 970 is increased. Further control of air removal and filtration capacity is provided by selecting a desired air removal capacity for fan assembly 190. Still more control of air removal and filtration capacity is provided by appropriately selecting radial size of aperture 950.

Referring to FIGS. 35A and 35B, there is shown an eighteenth embodiment segmented stackable filter assembly, generally referred to as 972 (hereinafter “stackable filter assembly 972”), for filtering a gas, such as indoor room air. Stackable filter assembly 972 comprises a first group 973 of one or more horizontally oriented, interconnected and stacked filter segments 974a, 974b and 974c. Stackable filter assembly 972 further comprises a second group 975 of one or more horizontally oriented, interconnected and stacked filter segments 976a, 976b and 976c. Each of first group 973 and second group 975 is connected by respective ones of air flow pipes 977a, 977b to a vertically oriented, central filter segment 978. Each of air flow pipes 977a,977b may be joined to central filter segment 978 by a face place 979 (only one of which is shown), if desired. It should be appreciated that stackable filter assembly 972 obtains increased air filtering capacity because a substantial amount of air flows through first group 973 of filter segments, second group 975 of filter segments, and thereafter also flows through central filter segment 978. Stackable filter assembly is more versatile than many prior art devices. For example, first group 973, second group 975 and central filter segment 978 may each be deployed in separate rooms of a residence, business establishment or other building structure while first group 973, second group 975 and central filter segment 978 remain interconnected.

With reference to FIG. 35C, there is shown a nineteenth embodiment segmented stackable flitter assembly, generally referred to as 980 (hereinafter “stackable filter assembly 980”) for filtering a gas, such as indoor room air. Stackable filter assembly 980 is substantially similar to stackable filter assembly 972, except fan assembly 190 includes a duct silencer or muffler device 981 for silencing or muffling noise produced by fan assembly 190. A muffler device suitable for this purpose may be of a type that may be available from HTG Supply, Incorporated located in Pittsburgh, Pa., U.S.A.

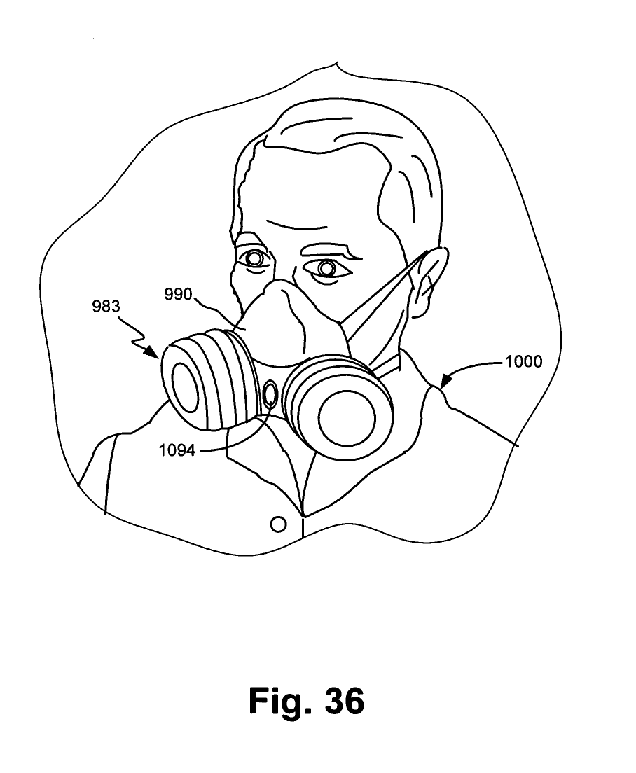

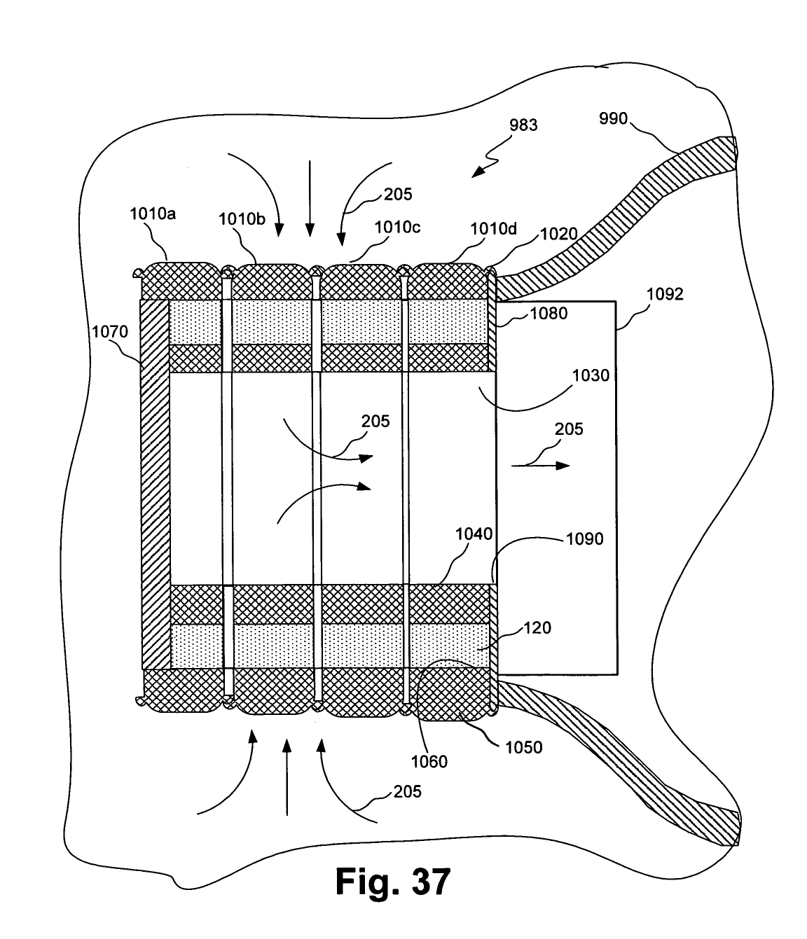

As seen in FIGS. 36 and 37, a twentieth embodiment segmented stackable filter assembly, generally referred to as 983 (hereinafter “stackable filter assembly 983”), is there shown for filtering a gas, such as indoor room air or outdoor air. It should be appreciated that, based on the teachings herein, the stackable filter concept has a number of various configurations. By way of example only, and not by way of limitation, the stackable filter concept may be used in combination with a face mask. In this regard, stackable filter assembly 983 is adapted to be removably connected to a face mask 990 to be worn by a user 1000 thereof. For example, user 1000 may be a fireman, military combat personnel or other person located in an environment where smoke, poisonous gases or other harmful air-borne contaminants are present. More specifically, stackable filter assembly 983 comprises a plurality of filter segments, such as filter segments 1010a, 1010b, 1010c and 1010d. The filter segments 1010a, 1010b, 1010c and 1010d are releasably interconnected by a snap-fit of adjacent lip members 1020. Each filter segment 1010a, 1010b, 1010c and 1010d has an air flow passageway 1030 centrally formed therethrough. Surrounding air flow passageway 1030 is an interior annular wire mesh 1040 and an exterior annular wire mesh 1050 spaced apart from interior wire mesh 1040, so as to define an annular gap 1060 that is filled with previously mentioned filter media 120. A distal end of stackable filter assembly 983 is closed by an end plate 1070 and a proximal end of stackable filter assembly 980 is removably connected to face mask 990. Filter assembly 983 is removably connected to face mask 990 by means of an annular connector plate 1080 that defines an orifice 1090 in communication with air flow passageway 1030. Stackable filter assembly 983 is removably connected to face mask 990 by snap-fit engagement of lip members 1020, as shown. In addition, a first one-way valve 1092 is connected to connector plate 1080 for allowing air flow only into face mask 990 in the direction of air flow line 205. A second one-way valve 1094 allows exhaled air only out of face mask 990. Configuration of stackable filter assembly 980 allows air to enter face mask 990 only through exterior wire mesh 1050, filter media 120, interior wire mesh 1040 and air flow passageway 1030, so that air breathed by user 1000 is properly filtered.

### Illustrative Methods:

An illustrative method associated with an exemplary embodiment for manufacturing the segmented stackable filter assembly will now be described.

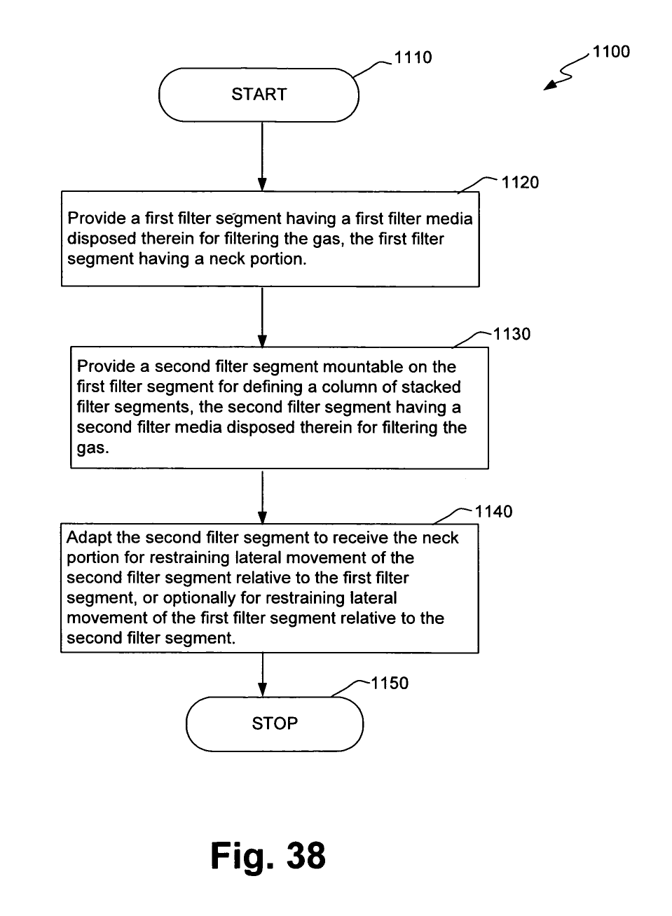

Referring to FIG. 38, an illustrative method, generally referred to as 1100, is provided for manufacturing a filter segment belonging to a segmented stackable filter assembly for filtering a gas. The method starts at a step 1110. At a step 1120, a first filter segment is provided having a first filter media disposed therein for filtering the gas, the first filter segment having a neck portion. At a step 1130, a second filter segment is provided that is mountable on the first filter segment for defining a column of stacked filter segments, the second filter segment having a second filter media disposed therein for filtering the gas. At a step 1140, the second filter segment is adapted to receive the neck portion for restraining lateral movement of the second filter segment relative to the first filter segment, or optionally for restraining lateral movement of the first filter segment relative to the second filter segment. The method stops at a step 1150.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawing, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

All patents, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Applicants reserve the right to physically incorporate into this specification any and all materials and information from any such patents, publications, scientific articles, web sites, electronically available information, and other referenced materials or documents to the extent such incorporated materials and information are not inconsistent with the description herein.

The written description portion of this patent includes all claims. Furthermore, all claims, including all original claims as well as all claims from any and all priority documents, are hereby incorporated by reference in their entirety into the written description portion of the specification, and Applicants reserve the right to physically incorporate into the written description or any other portion of the application, any and all such claims. Thus, for example, under no circumstances may the patent be interpreted as allegedly not providing a written description for a claim on the assertion that the precise wording of the claim is not set forth in haec verba in the written description portion of the patent.

The claims will be interpreted according to law. However, and notwithstanding the alleged or perceived ease or difficulty of interpreting any claim or portion thereof, under no circumstances may any adjustment or amendment of a claim or any portion thereof during prosecution of the application or applications leading to this patent be interpreted as having forfeited any right to any and all equivalents thereof that do not form a part of the prior art.

All of the features disclosed in this specification may be combined in any combination. Thus, unless expressly stated otherwise, each feature disclosed is only an example of a generic series of equivalent or similar features.

It is to be understood that while the invention has been described in conjunction with the detailed description thereof, the foregoing description is intended to illustrate and not limit the scope of the invention, which is defined by the scope of the appended claims. Thus, from the foregoing, it will be appreciated that, although specific embodiments of the invention have been described herein for the purpose of illustration, various modifications may be made without deviating from the spirit and scope of the invention. Other aspects, advantages, and modifications are within the scope of the following claims and the present invention is not limited except as by the appended claims.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that various substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, the terms “comprising”, “including”, “containing”, etc. are to be read expansively and without limitation. The methods and processes illustratively described herein suitably may be practiced in differing orders of steps, and that they are not necessarily restricted to the orders of steps indicated herein or in the claims.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by various embodiments and/or preferred embodiments and optional features, any and all modifications and variations of the concepts herein disclosed that may be resorted to by those skilled in the art are considered to be within the scope of this invention as defined by the appended claims.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

It is also to be understood that as used herein and in the appended claims, the singular forms “a,” “an,” and “the” include plural reference unless the context clearly dictates otherwise, the term “X and/or Y” means “X” or “Y” or both “X” and “Y”, and the letter “s” following a noun designates both the plural and singular forms of that noun. In addition, where features or aspects of the invention are described in terms of Markush groups, it is intended and those skilled in the art will recognize, that the invention embraces and is also thereby described in terms of any individual member or subgroup of members of the Markush group.

Other embodiments are within the following claims. The patent may not be interpreted to be limited to the specific examples or embodiments or methods specifically and/or expressly disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicant(s).

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

Other modifications and implementations will occur to those skilled in the art without departing from the spirit and the scope of the invention as claimed. For example, rather than a prefilter shroud wrapped around an exterior of a filter segment, a prefilter cassette instead may be disposed within any of the exemplary embodiments of the filter segments. Disposing such a prefilter cassette within the filter segment will reduce the risk that the fibrous and relatively soft material comprising the prefilter shroud will be damaged due to scraping and impacts by nearby objects, such as furniture. Accordingly, the description hereinabove is not intended to limit the invention, except as indicated in the following claims.

Therefore, provided herein are a segmented stackable filter assembly for filtering a gas and method of manufacturing same.

What is claimed is:

1. A segmented stackable filter assembly for filtering a gas, comprising:
(a) a first filter segment having a first filter media disposed therein for filtering the gas, said first filter segment having a neck portion; and
(b) a second filter segment mountable on said first filter segment and having a second filter media disposed therein for filtering the gas, said second filter segment being adapted to receive the neck portion for restraining lateral movement of said second filter segment relative to said first filter segment, or optionally for restraining lateral movement of said first filter segment relative to said second filter segment.

2. The segmented stackable filter assembly of claim 1, further comprising a suction device removably supportable by the neck portion and adapted to be in suction communication with the first filter media and the second filter media for suctioning the gas through the first filter media and the second filter media.

3. The segmented stackable filter assembly of claim 1, further comprising a seal adapted to be interposed between said first filter segment and said second filter segment for sealing an interface therebetween.

4. The segmented stackable filter assembly of claim 1, wherein said first filter segment and said second filter segment are arrangeable end-to-end for defining a column of stacked filter segments.

5. The segmented stackable filter assembly of claim 4, further comprising:
(a) a platform adapted to be removably connected to the column of stacked filter segments for supporting the column of stacked filter segments thereon; and
(b) a plurality of wheels connected to said platform for transporting said platform and the column of stacked filter segments supported thereon.

6. The segmented stackable filter assembly of claim 4, further comprising a plurality of wheels connected to the column of stacked filter segments for transporting the column of stacked filter segments.

7. The segmented stackable filter assembly of claim 1, further comprising an ultraviolet light source connected to at least one of said first filter segment and said second filter segment for sanitizing the gas.

8. The segmented stackable filter assembly of claim 1, further comprising a clamp fastener arrangement associated with said first filter segment and said second filter segment for releasably interconnecting said first filter segment and said second filter segment.

9. The segmented stackable filter assembly of claim 1, further comprising a threaded fastener arrangement associated with said first filter segment and said second filter segment for releasably interconnecting said first filter segment and said second filter segment.

10. The segmented stackable filter assembly of claim 1, further comprising a pin fastener arrangement associated with said first filter segment and said second filter segment for releasably interconnecting said first filter segment and said second filter segment.

11. The segmented stackable filter assembly of claim 1, further comprising:
(a) a first replaceable filter cartridge adapted to be disposed in said first filter segment for containing the first filter media; and
(b) a second replaceable filter cartridge adapted to be disposed in said second filter segment for containing the second filter media.

12. The segmented stackable filter assembly of claim 11, wherein said first filter segment and said second filter segment comprise a first hinged door and a second hinged door, respectively, for allowing access to said first replaceable filter cartridge and said second replaceable filter cartridge.

13. The segmented stackable filter assembly of claim 1, wherein said first filter segment and said second filter segment are adapted to be disposed in an air duct.

14. The segmented stackable filter assembly of claim 1, further comprising a central filter segment connected to said first filter segment and said second filter segment.

15. The segmented stackable filter assembly of claim 1, wherein said first filter segment and said second filter segment are adapted to be connected to a face mask.

16. A segmented stackable filter assembly for filtering a gas, comprising a plurality of filter segments mountable one upon the other, each of said filter segments including:
(a) an annular outer wire mesh having a first end portion and a second end portion;
(b) an annular inner wire mesh centered inwardly of said outer wire mesh and spaced apart therefrom for defining a gap therebetween sized to receive a filter media therein, said inner wire mesh defining a centrally-located gas flow channel in communication with the filter media, said inner wirer mesh having a first end portion and a second end portion;
(c) a first end plate spanning the first end portion of said outer wire mesh, and the first end portion of said inner wire mesh and the filter media therebetween, said first end plate defining an opening therethrough in communication with the gas flow channel;
(d) a second end plate coextensive with said first end plate and spaced apart therefrom for defining a filtering zone sized to collectively receive said outer wire mesh, the filter media and the inner wire mesh, said second end plate having an outwardly extending neck portion defining a bore therethrough in communication with the gas flow channel, the neck portion being receivable in close-fitting relationship in the opening defined by said first end plate for restraining lateral movement of said first end plate relative to said second end plate, whereby lateral movement of adjacent ones of said plurality of filter segments is restrained while lateral movement of said first end plate relative to said second end plate is restrained;
(e) an elastomeric seal interposed between said second end plate and said first end plate for sealing an interface therebetween, whereby said seal prevents the gas from entering the interface while said seal is interposed between said second end plate and said first end plate;
(f) an electrically operable fan removably supportable by the neck portion and in communication with the bore for suctioning the gas through said outer wire mesh, the filter media, said inner wire mesh, the gas flow channel and the bore, whereby the gas is filtered and removed from said filter segment while the gas is suctioned through said outer wire mesh, the filter media, said inner wire mesh, the gas flow channel and the bore; and
(g) a fastener arrangement adapted to releasably interconnect adjacent ones of said plurality of filter segments.

17. The segmented stackable filter assembly of claim 16, wherein said plurality of filter segments are adapted to be arranged end-to-end for defining a column of stacked filter segments.

18. The segmented stackable filter assembly of claim 17, further comprising:
(a) a platform adapted to be removably connected to the column of stacked filter segments for supporting the column of stacked filter segments thereon; and
(b) a plurality of wheels connected to said platform for transporting said platform and the column of stacked filter segments thereon.

19. The segmented stackable filter assembly of claim 16, further comprising a plurality of wheels connected to at least one of said plurality of filter segments for transporting the at least one of said plurality of filter segments.

20. The segmented stackable filter assembly of claim 16, further comprising an ultraviolet light source connected to at least one of said plurality of filter segments for deodorizing the gas and for killing microorganisms in the gas.

21. The segmented stackable filter assembly of claim 16, wherein said fastener arrangement is a clamp fastener arrangement, a threaded fastener arrangement or optionally a pin fastener arrangement.

22. The segmented stackable filter assembly of claim 16, further comprising a replaceable filter cartridge containing the filter media and adapted to be disposed in the gap.

23. The segmented stackable filter assembly of claim 22, wherein said filter segment comprises a hinged door disposed opposite said filter cartridge for allowing access to said filter cartridge.

24. The segmented stackable filter assembly of claim 16, wherein said filter segment is adapted to be disposed in an air duct.

25. The segmented stackable filter assembly of claim 16, wherein said plurality of filter segments comprises a first group of filter segments and a second group of filter segments connected to a central filter segment.

26. The segmented stackable filter assembly of claim 25, wherein said central filter segment comprises a muffler.

27. The segmented stackable filter assembly of claim 16, wherein said filter segment is adapted to be connected to a face mask.

28. A method of manufacturing a segmented stackable filter assembly for filtering a gas, comprising the steps of:
(a) providing a first filter segment having a first filter media disposed therein for filtering the gas, the first filter segment having a neck portion;
(b) providing a second filter segment mountable on the first filter segment for defining a column of stacked filter segments, the second filter segment having a second filter media disposed therein for filtering the gas; and
(c) adapting the second filter segment to receive the neck portion for restraining lateral movement of the second filter segment relative to the first filter segment, or optionally for restraining lateral movement of the first filter segment relative to the second filter segment.

29. The method of claim 28, further comprising the step of providing a suction device supportable on the neck portion and adapted to be in suction communication with the first filter media and the second filter media for suctioning the gas through the first filter media and the second filter media.

30. The method of claim 28, further comprising the step of affixing a seal in an interface defined between the first filter segment and the second filter segment for sealing the interface.

31. The method of claim 28, further comprising the step of providing a wheeled platform removably connectable to the column of stacked filter segments for transporting the column of stacked filter segments.

32. The method of claim 28, further comprising the step of connecting a plurality of wheels to at least one of the first filter segment and the second filter segment for transporting the at least one of the first filter segment and the second filter segment.

33. The method of claim 28, further comprising the step of connecting an ultraviolet light source to at least one of the first filter segment and the second filter segment for sanitizing the gas.

34. The method of claim 28, further comprising the step of providing a fastener arrangement associated with the first filter segment and the second filter segment for releasably interconnecting the first filter segment and the second filter segment.

35. The method of claim 28,
(a) wherein the first filter media is disposed in a replaceable first filter cartridge; and
(b) wherein the second filter media is disposed in a replaceable second filter cartridge.

36. The method of claim 35, wherein the step of providing a first filter segment comprises the step of providing a first filter segment having a first hinged door associated with the first filter cartridge for allowing access to the first filter cartridge.

37. The method claim 35, wherein the step of providing a second filter segment comprises the step of providing a second filter segment having a second hinged door associated with the second filter cartridge for allowing access to the second filter cartridge.

38. The method of claim 28, further comprising the step of substantially surrounding the first filter segment and the second filter segment with a first prefilter and a second prefilter, respectively, for prefiltering the gas.

39. The method of claim 28, further comprising the step of adapting the first filter segment and the second filter segment for being disposed in an air duct.

40. The method of claim 28, further comprising the step of adapting the first filter segment and the second filter segment for connection to a face mask.
